(19) United States
(12) Patent Application Publication
(10) Pub. No.: US 2026/0243605 A1
(43) Pub. Date: Aug. 20, 2026

(54) HYPERSPECTRAL PHASOR THERMOGRAPHY

(71) Applicant: Georgia Tech Research Corporation, Atlanta, GA (US)

(72) Inventors: Shu JIA, Atlanta, GA (US); Dingding HAN, Atlanta, GA (US)

(21) Appl. No.: 19/542,216

(22) Filed: Feb. 17, 2026

Related U.S. Application Data
(60) Provisional application No. 63/759,683, filed on Feb. 18, 2025.

(51) Int. Cl. G01J 5/48; G01J 5/00; G01J 5/20; G06T 7/90

(52) U.S. Cl. CPC G01J 5/48; G01J 5/0025; G01J 5/20; G06T 7/90; G01J 2005/0077; G01J 2005/202; G06T 2207/10024; G06T 2207/10048; G06T 2207/20084

(57) ABSTRACT

An exemplary system and method are disclosed for generating high-resolution visible images from infrared (IR) thermal radiation, using (i) full-harmonics thermal phasor transformation, and (ii) a trained AI model or a combination of clustering operation and thermal decomposition. In some implementations, the exemplary system and method use hyperspectral radiation modeling and thermal phasor analysis to facilitate a multiparametric depiction of key thermal fingerprints. Specifically, the exemplary system and method can employ, via thermal phasor transformation and thermal decomposition, full-harmonic phasor energy and high-order thermal phasor perception to provide improved material classification and high-resolution extraction of physical attributes (e.g., temperature, emissivity, and texture modulation) from a thermal scene.

### RELATED APPLICATION

This application claims priority to, and the benefit of, U.S. Provisional Patent Application No. 63/759,683, filed Feb. 18, 2025, entitled “HYPERSPECTRAL PHASOR THERMOGRAPHY,” which is incorporated by reference herein in its entirety.

### BACKGROUND

Thermography is a non-contact imaging technology that converts infrared thermal radiation into visible images to capture passive infrared thermal radiation independent of ambient light conditions. Thermography is used in industrial inspection, building diagnostics, security, and healthcare for navigation, sensing, thermodynamics, and material sciences. In these applications, thermography facilitates the detection of heat patterns (e.g., for equipment monitoring), energy efficiency analysis, and physiological assessment (e.g., in healthcare). However, current thermography systems have limited resolution, are sensitive to environmental conditions, and struggle to extract fine-grained information beyond temperature due to the spectral ambiguity in thermography. Unlike quasi-passive systems (e.g., visible optical imaging), thermal radiations originating from target objects and environmental scattering exhibit broad and overlapping emission spectra, leading to the ghosting effect, a phenomenon when the texture details are immersed and thus imperceptible in the strong direct emission. Such lack of spectral resolution complicates the interpretation of heat signals, which cannot be resolved using standard optical filtering settings.

There is a benefit to improving the thermography and HSI systems for thermal radiation imaging.

### SUMMARY

An exemplary system and method are disclosed for generating high-resolution visible images from infrared (IR) thermal radiation, using (i) full-harmonics thermal phasor transformation, and (ii) a trained AI model or a combination of clustering operation and thermal decomposition. In some implementations, the exemplary system and method use hyperspectral radiation modeling and thermal phasor analysis to facilitate a multiparametric depiction of key thermal fingerprints. Specifically, the exemplary system and method can employ, via thermal phasor transformation and thermal decomposition, full-harmonic phasor energy and high-order thermal phasor perception to provide improved material classification and high-resolution extraction of physical attributes (e.g., temperature, emissivity, and texture modulation) from a thermal scene.

Current thermographic and HSI systems experience spectral ambiguity caused by broad, overlapping long-wave infrared (LWIR) emission, resulting in ghosting effects where texture details are immersed within thermal emission and become imperceptible. In contrast, the exemplary system and method facilitate enhanced separation of thermal components, preserving fine-scale texture and enabling accurate decomposition (unmixing) of temperature, emissivity, and texture-related contributions. By using hyperspectral radiation modeling and high-order thermal phasor features, the exemplary system and method address the ghosting effects and texture loss observed in the current thermographic and HSI systems.

Current radar-based physiological monitoring systems employ specialized hardware and complex calibration, yet still provide limited spatial information (e.g., no subtle vital signs). In contrast, the exemplary system and method employ simple sensors (e.g., cameras) and filters (e.g., lenses), yet provide high-resolution, passive monitoring of subtle physiological variations (e.g., respiration-induced thermal modulation, pulsatile thermal changes) without requiring physical contact or a line of sight, which allows extraction of human vital signs in ambient indoor environments.

Current visible-light imaging systems rely on ambient light and cannot operate in low-light or visually obscured conditions. In contrast, the exemplary system and method operate on emitted thermal radiation, facilitating lighting-independent operation and integration across healthcare, surveillance, and environmental monitoring. The use of phasor-based transformation and analysis also provides the exemplary system and method with computational efficiency against non-uniform environmental radiation sources, allowing compatibility with current thermography systems without requiring multispectral optics or active illumination.

In an aspect, a thermographic imaging and vision system is disclosed comprising: at least one two-dimensional (2D) sensor (e.g., forward-looking infrared camera) configured to capture one or more thermal radiance images having pixels; at least one filter (e.g., filtered channel, unfiltered channel) operatively coupled to the at least one sensor to facilitate capture of one or more thermal radiance images of a person, wherein the at least one filter is configured to filter the captured one or more thermal radiance images at one or more predefined frequency bands (e.g., long-wave infrared (LWIR) bands) to provide hyperspectral information across an electromagnetic spectrum for each pixel in the captured one or more thermal radiance images; and a controller operatively coupled to the at least one sensor, the controller including: a processor; and a memory having instructions stored thereon, wherein execution of the instructions causes the processor to: receive, via the at least one sensor, the filtered one or more thermal radiance images; generate, via a thermal phasor transformation operation, one or more phasor data (e.g., plots) at one or more harmonics using the filtered one or more thermal radiance images, wherein each phasor data represents characteristics of thermal radiance at the one or more predefined frequency bands; generate, via a phasor modulation operation, a texture modulation map within a phasor data of the one or more phasor data at a pre-defined high-order harmonic (e.g., 4^{th} harmonic), wherein the generated texture modulation map includes texture values represented by the phasor data; generate, via a trained AI model or cluster algorithm, a material segmentation map by partitioning phasors within the generated one or more phasor data into one or more clusters, wherein the material segmentation map includes emissivity values of materials represented by the phasors; generate, via the trained AI model or a thermal decomposition algorithm, a temperature map having a plurality of temperature values, wherein each temperature value is computed using (i) the emissivity values from the generated material segmentation map and (ii) the texture values from the generated texture modulation map; generate a phasor thermographic image by combining at least two of the generated material segmentation map (e.g., as color hue), the generated temperature map (e.g., as saturation), and the generated texture modulation map (e.g., as brightness); and output the generated phasor thermographic image, wherein the output is subsequently employed for health monitoring or medical diagnoses.

In some embodiments, the generation of the texture modulation map is based on phasor modulation within the phasor data at a 4^{th} harmonic.

In some embodiments, the partitioning of the phasors within the generated one or more phasor data into the one or more clusters includes: selecting one or more phasors as one or more cluster centers; partitioning phasors located within a predefined distance from the one or more cluster centers into one or more clusters; and assigning a value (e.g., color, sum of squared distances from each phasor to its center) to each of the one or more clusters, wherein each cluster forms a segment of the material segmentation map.

In some embodiments, the instructions to generate the temperature map includes: instructions to determine, via an material-emissivity library, an emissivity value (e) for a given pixel in the one or more thermal radiance images, wherein the given pixel corresponds to a segmented material in the generated material segmentation map; instructions to determine a lighting factor value (e.g., surface view factor V) for the given pixel in the one or more thermal radiance images, wherein the lighting factor for the given pixel corresponds to a segmented texture modulation in the generated texture modulation map; and instructions to determine a temperature value for the given pixel in the one or more thermal radiance images using the determined emissivity value and the determined lighting factor for the given pixel, wherein a plurality of determined temperature values for a plurality of pixels in the one or more thermal radiance images form the generated temperature map.

In some embodiments, at least one sensor further includes a metasurface.

In some embodiments, the at least one sensor is selected from the group consisting of a red-green-blue camera and a forward-looking infrared camera.

In some embodiments, the trained AI model is a neural network model.

In some embodiments, the execution of the instructions further causes the processor to: receive a first thermal radiance image in the one or more thermal radiance images as a fixed reference (e.g., for noise removal); and configure (e.g., scale, rotate, etc.) other thermal radiance images to be aligned with the received first thermal radiance image.

In some embodiments, the one or more predefined frequency bands include long-wave infrared bands.

In some embodiments, the controller is located in part in a cloud infrastructure including a network interface configured to communicatively operate with the at least one sensor through a network, wherein generation of the phasor thermographic image is performed at the cloud infrastructure.

In some embodiments, the controller is located in part in a mobile device including a network interface configured to communicatively operate with the at least one sensor through a network, wherein generation of the phasor thermographic image is performed at the mobile device.

In some embodiments, the at least one filter includes (i) a first filter that is coupled to a first sensor and (ii) a second filter that is coupled to a second sensor, wherein outputs of the first sensor and the second sensor collectively provide hyperspectral information across the electromagnetic spectrum for the each pixel in the captured one or more thermal radiance images.

In some embodiments, the at least one filter includes a first filter and a second filter, each movable via an actuator to be disposed before the at least one filter, wherein acquisition of outputs of the at least one filter (i) at the first filter at a first time instance and (ii) at the second filter at a second time instance collectively provide hyperspectral information across the electromagnetic spectrum for the each pixel in the captured one or more thermal radiance images.

In another aspect, a method is disclosed comprising: receiving, via at least one two-dimensional (2D) sensor (e.g., forward-looking infrared camera) coupled to at least one filter or metasurface, filtered one or more thermal radiance images of a person, wherein the at least one filter or metasurface is configured to filter one or more thermal radiance images captured by the at least one sensor at one or more predefined frequency bands (e.g., long-wave infrared (LWIR) bands) to provide hyperspectral information across an electromagnetic spectrum for each pixel in the captured one or more thermal radiance images; generating, via a thermal phasor transformation operation, one or more phasor data (e.g., plots) at one or more harmonics using the filtered one or more thermal radiance images, wherein each phasor data represents characteristics of thermal radiance at the one or more predefined frequency bands; generating, via a phasor modulation operation, a texture modulation map within a phasor data of the one or more phasor data at a pre-defined high-order harmonic (e.g., 4^{th} harmonic), wherein the generated texture modulation map includes texture values represented by the phasor data; generating, via a trained AI model or cluster algorithm, a material segmentation map by partitioning phasors within the generated one or more phasor data into one or more clusters, wherein the material segmentation map includes emissivity values of materials represented by the phasors; generating, via the trained AI model or a thermal decomposition algorithm, a temperature map having a plurality of temperature values, wherein each temperature value is computed using (i) the emissivity values from the generated material segmentation map and (ii) the texture values from the generated texture modulation map; generating a phasor thermographic image by combining at least two of the generated material segmentation map (e.g., as color hue), the generated temperature map (e.g., as saturation), and the generated texture modulation map (e.g., as brightness); and outputting the generated phasor thermographic image, wherein the output is subsequently employed for health monitoring or medical diagnoses.

In some embodiments, the partitioning of the phasors within the generated one or more phasor data into the one or more clusters includes: selecting one or more phasors as one or more cluster centers; partitioning phasors located within a predefined distance from the one or more cluster centers into one or more clusters; and assigning a value (e.g., color, sum of squared distances from each phasor to its center) to each of the one or more clusters, wherein each cluster forms a segment of the material segmentation map.

In some embodiments, generating the temperature map includes: determining, via a material-emissivity library, an emissivity value (e) for a given pixel in the one or more thermal radiance images, wherein the given pixel corresponds to a segmented material in the generated material segmentation map; determining a lighting factor value (e.g., surface view factor V) for the given pixel in the one or more thermal radiance images, wherein the lighting factor for the given pixel corresponds to a segmented texture modulation in the generated texture modulation map; and determining a temperature value for the given pixel in the one or more thermal radiance images using the determined emissivity value and the determined lighting factor for the given pixel, wherein a plurality of determined temperature values for a plurality of pixels in the one or more thermal radiance images form the generated temperature map.

In some embodiments, the generation of the texture modulation map is based on phasor modulation within the phasor data at a 4^{th} harmonic.

In some embodiments, the filtered one or more thermal radiance images are acquired via a single sensor that operates with a plurality of filters that are configured to move during the acquisition.

In some embodiments, the filtered one or more thermal radiance images are acquired via multiple sensors that each operate with a filter.

In yet another aspect, a non-transitory computer-readable medium having instructions stored thereon is disclosed, wherein execution of the instructions by a processor causes the processor to: receive, via at least one sensor, filtered one or more thermal radiance images; generate, via a thermal phasor transformation operation, one or more phasor data (e.g., plots) at one or more harmonics using the filtered one or more thermal radiance images, wherein each phasor data represents characteristics of thermal radiance at one or more predefined frequency bands; generate, via a phasor modulation operation, a texture modulation map within a phasor data of the one or more phasor data at a pre-defined high-order harmonic (e.g., 4^{th} harmonic), wherein the generated texture modulation map includes texture values represented by the phasor data; generate, via a trained AI model or cluster algorithm, a material segmentation map by partitioning phasors within the generated one or more phasor data into one or more clusters, wherein the material segmentation map includes emissivity values of materials represented by the phasors; generate, via the trained AI model or a thermal decomposition algorithm, a temperature map having a plurality of temperature values, wherein each temperature value is computed using (i) the emissivity values from the generated material segmentation map and (ii) the texture values from the generated texture modulation map; generate a phasor thermographic image by combining at least two of the generated material segmentation map (e.g., as color hue), the generated temperature map (e.g., as saturation), and the generated texture modulation map (e.g., as brightness); and output the generated phasor thermographic image, wherein the output is subsequently employed for health monitoring or medical diagnoses.

### BRIEF DESCRIPTION OF DRAWINGS

FIGS. 1A-1D each shows an example thermographic imaging and analysis system for transforming infrared (IR) thermal radiation into visible images using (i) full-harmonics thermal phasor transformation and (ii) a trained AI model or a combination of clustering operation and thermal decomposition, in accordance with an illustrative embodiment.

FIG. 2 shows an example method of hyperspectral thermographic analysis and imaging (also referred to as thermal phasor analysis), in accordance with an illustrative embodiment.

FIG. 3A shows an example operation flow of the exemplary thermal phasor analysis system and method, in accordance with an illustrative embodiment.

FIG. 3B shows an example spectral thermal radiation through multiple infrared filters (of the exemplary system).

FIG. 3C shows an example image registration and preprocessing of hyperspectral thermal images, which are subsequently used for the phasor analysis in FIG. 3A.

FIG. 3D shows example physical noises and their interaction with various objects (e.g., chair, curtain) within the environment.

FIG. 3E shows an example denoising of thermal images based on the material classification in the thermal phasor domain.

FIGS. 4A-4B each shows an experimental hyperspectral phasor thermography system, as described in relation to FIGS. 1-3.

FIG. 4C shows a characterization of the experimental system with phantom and botanical specimens.

FIG. 4D shows the emissivity spectra of (i) the resins forming a phantom hand skeleton, (ii) the flowing components, including fresh and dry petals and leaves, and (iii) obtained from an emissivity library.

FIG. 4E shows hyperspectral thermal images of a human object generated by (i) the current facial infrared thermography system and (ii) the experimental system with phasor thermography (PTG).

FIG. 4F shows the thermographic detection of human vital signs using the experimental system.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

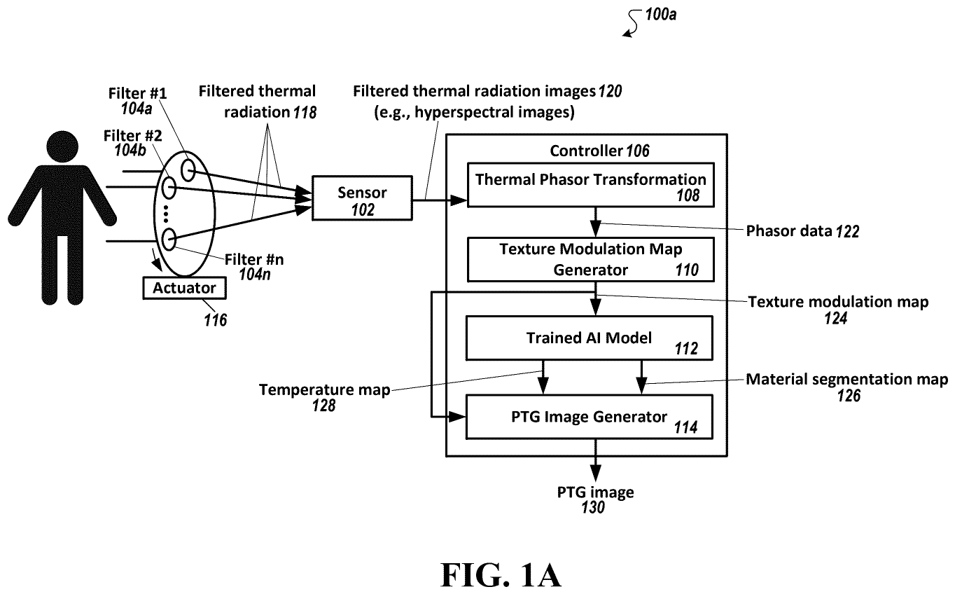

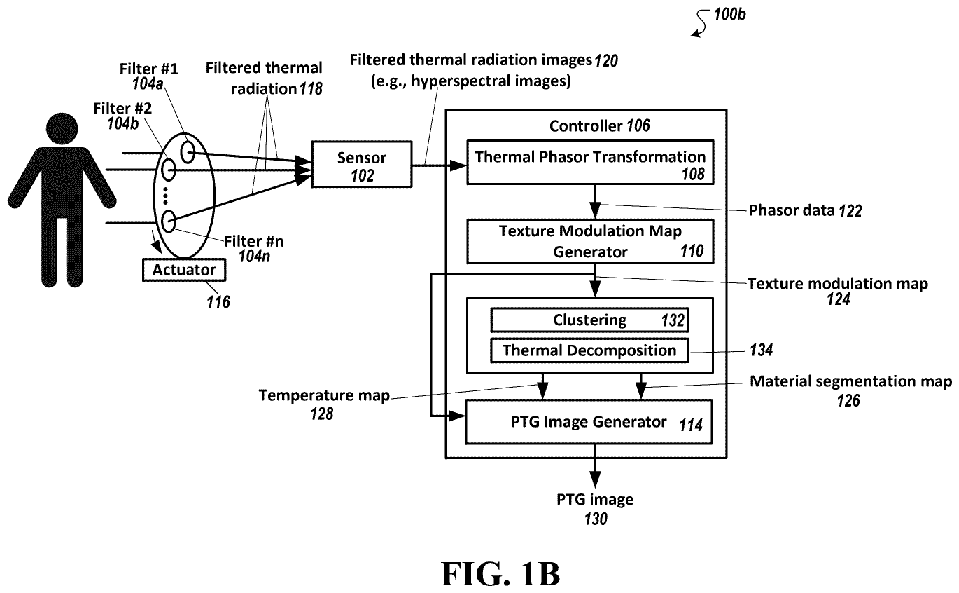

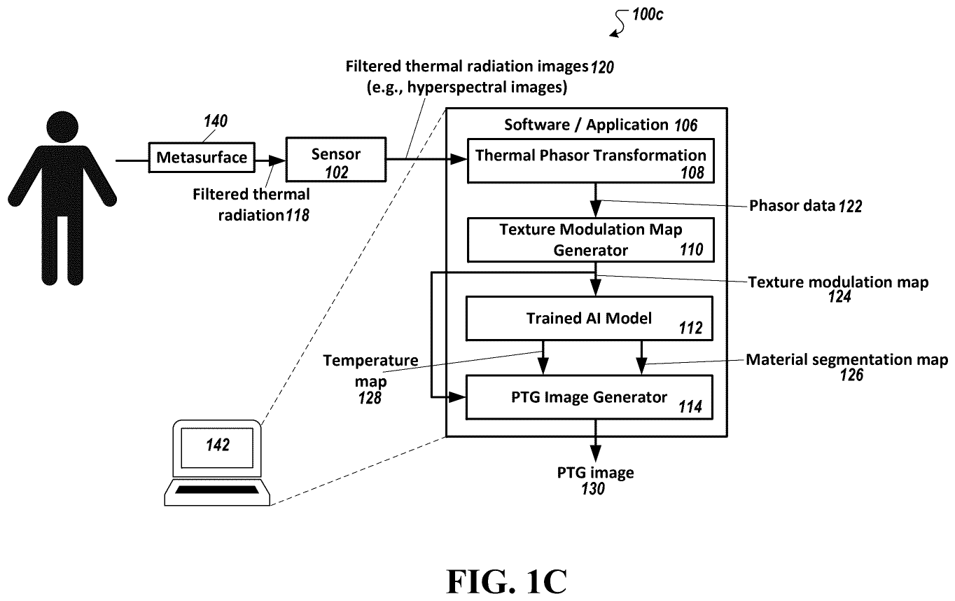

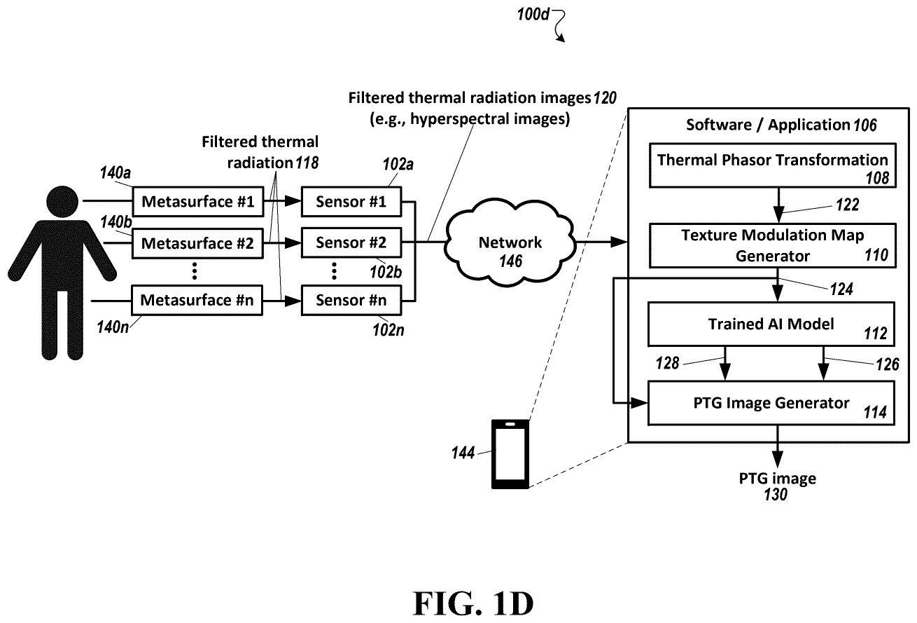

FIGS. 1A-1D each shows an example thermographic imaging and analysis system 100 (shown as 100a-100d) (also referred to as a phasor thermography system) for transforming infrared (IR) thermal radiation into visible images (e.g., PTG image) using (i) full-harmonics thermal phasor transformation and (ii) a trained AI model or a combination of clustering operation and thermal decomposition, in accordance with an illustrative embodiment.

The exemplary system 100 includes (i) at least one sensor 102 and (ii) a controller 106. In FIG. 1A, at least one filter 104 (e.g., filter channel or unfiltered channel), including filters 104a-104n (shown as filters #1-#n), is operatively coupled to the sensor 102, and the controller 106 employs a trained AI model to generate a material segmentation map 126 and a temperature map 128. In FIG. 1B, the controller 106 employs a clustering algorithm 132 and a thermal decomposition algorithm 134 to generate the material segmentation map 126 and the temperature map 128. In FIG. 1C, the sensor 102 has a metasurface 140. In FIG. 1D, each in a set of sensors 102a-102n (shown as sensor #1-#n) has a respective metasurface in a set of metasurfaces 140a-140n (shown as metasurface #1-#n).

Sensors (102). In the examples shown in FIGS. 1A-1B, the sensor 102 is configured to (i) capture/acquire images 120 (e.g., hyperspectral images) of the filtered thermal radiation 118 from the filters 104a-104n, and (ii) transmit the filtered thermal radiation images 120 to the controller 106. The filtered thermal radiation 118 is the thermal radiation (i) emitted from a person and (ii) filtered, by the filters 104a-104n, at one or more predefined frequency bands, to provide hyperspectral information across an electromagnetic spectrum for each pixel in the filtered thermal radiation images 120. In some embodiments, the sensor 102 is a red-green-blue (RGB) camera or a forward-looking infrared camera. In some embodiments, the predefined frequency bands include long-wave infrared (LWIR) bands.

In FIGS. 1A-1, the filters 104a-104n are located on a wheel that is actuated by an actuator 116. When the wheel is actuated, the acquisition, via the sensor 102, of outputs (e.g., filtered thermal radiation 118) of the filter 104a at a first time instance, of the filter 104b at a second time instance, . . . , and of the filter 104n at an n^{th} time instance collectively provides the hyperspectral information across the electromagnetic spectrum for each pixel in the images 120.

In the examples shown in FIGS. 1C-1D, each sensor 102 (e.g., 102a-102n) is operatively coupled to a metasurface 140 (e.g., 140a-140n). The sensor 102 (e.g., 102a-102n) is configured to (i) capture/acquire images 120 of the filtered thermal radiation 118 from the filters 104a-104n, and (ii) transmit, locally (see FIG. 1C) or via a network 146 (see FIG. 1D), the filtered thermal radiation images 120 to the controller 106.

In some embodiments, each metasurface is configured to filter the radiation emitted from the person at the predefined frequency bands (e.g., LWIR bands), and the acquisition, via the sensor 102 (e.g., 102a-102n), of outputs (e.g., filtered thermal radiation 118) of the metasurface 140 (e.g., 140a-140n) collectively provides hyperspectral information across the electromagnetic spectrum for each pixel in the images 120.

Controller (106). In the examples shown in FIGS. 1A, 1C, and 1D, the controller 106 includes a thermal phasor transformation operation 108, a texture modulation map generator 110, a trained AI model 112, and a phasor thermography (PTG) image generator 114. As shown, the controller 106 is configured to receive, from the sensor 102 (see FIGS. 1A, 1C) or the plurality of sensors 102a-102n (see FIG. 1D), the filtered thermal radiation images 120. The controller 106 is then configured to generate, via the thermal phasor transformation operation 108 (e.g., implemented using Equations 1 and 2), one or more phasor data 122 (e.g., plots, texture data) at one or more harmonics (e.g., 1^{st} 2^{nd}, 3^{rd}, 4^{th}, etc.) using the filtered thermal radiation images 120. Each phasor data can represent characteristics of thermal radiance at the predefined frequency bands.

The texture modulation map generator 110, operatively coupled to the thermal phasor transformation operation 108, receives the one or more phasor data 122 from the operation 108. The controller 106 is then configured to generate, via the texture modulation map generator 110, a texture modulation map 124 within a phasor data of the one or more phasor data 122 at a predefined high-order harmonic (e.g., 4^{th} harmonic). The texture modulation map 124 can include texture values represented by the phasor data.

The trained AI model 112, operatively coupled to the texture modulation map generator 110, receives the texture modulation map 124 from the generator 110. The controller 106 is then configured to generate, via the trained AI model 112, the material segmentation map 126 by partitioning phasors within the one or more phasor data 122 into one or more clusters, where the material segmentation map 126 includes emissivity values of materials represented by the phasors. In some embodiments, the partitioning of the phasors within the one or more phasor data 122 into the one or more clusters includes (i) selecting one or more phasors (e.g., within the phasor data 122) as one or more cluster centers, (ii) partitioning phasors located within a predefined distance from the one or more cluster centers into the one or more clusters, and (iii) assigning a value (e.g., color, sum of squared distances from each phasor to its respective cluster center) to each of the one or more clusters. The one or more clusters collectively form the material segmentation map 126, where each cluster forms a segment of the material segmentation map 126.

The controller 106 is then configured to generate, via the trained AI model 112, the temperature map 128 having a plurality of temperature values (denoted as T), where each temperature value can be computed using (i) the emissivity values from the generated material segmentation map 126 and (ii) the texture values (e.g., lighting factor) from the texture modulation map 124 (see Equations 7, 9, 11). In some embodiments, the trained AI model 112 is a neural network model.

In some embodiments, the generation of the temperature map 128 includes (i) determining, via a material-emissivity library, an emissivity value (denoted as e) for a given pixel in the filtered thermal radiation images 120, where the given pixel corresponds to a segmented material in the material segmentation map 126, (ii) determining a lighting factor value (e.g., surface view factor, denoted as V) for the given pixel in the images 120, where the lighting factor corresponds to a segmented texture modulation in the texture modulation map 124, and (iii) determining a temperature value (denoted as T) for the given pixel in the images 120 using the determined emissivity value and the determined lighting factor for the given pixel (see Equations 7, 9, 11). The plurality of determined temperature values for a plurality of pixels in the images 120 can form the temperature map 128.

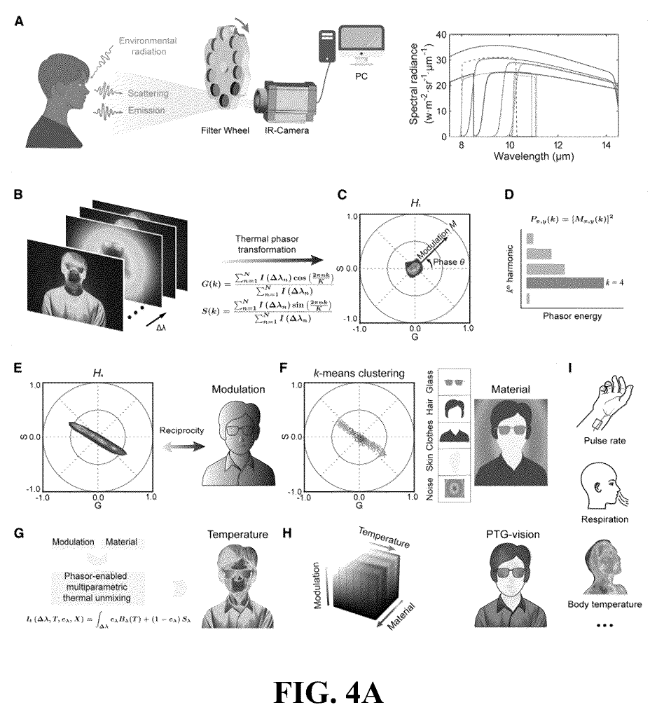

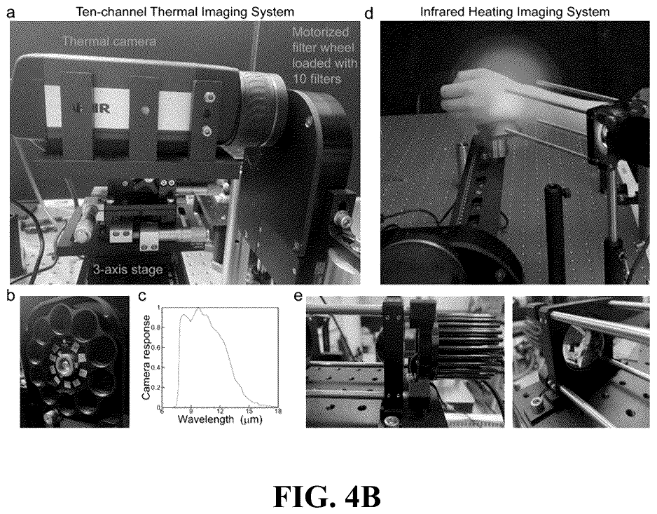

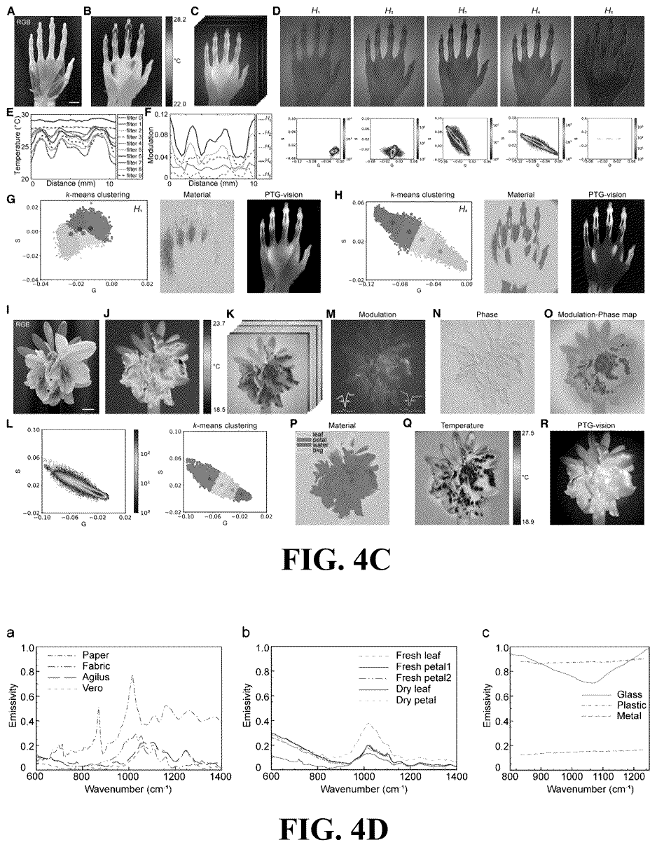

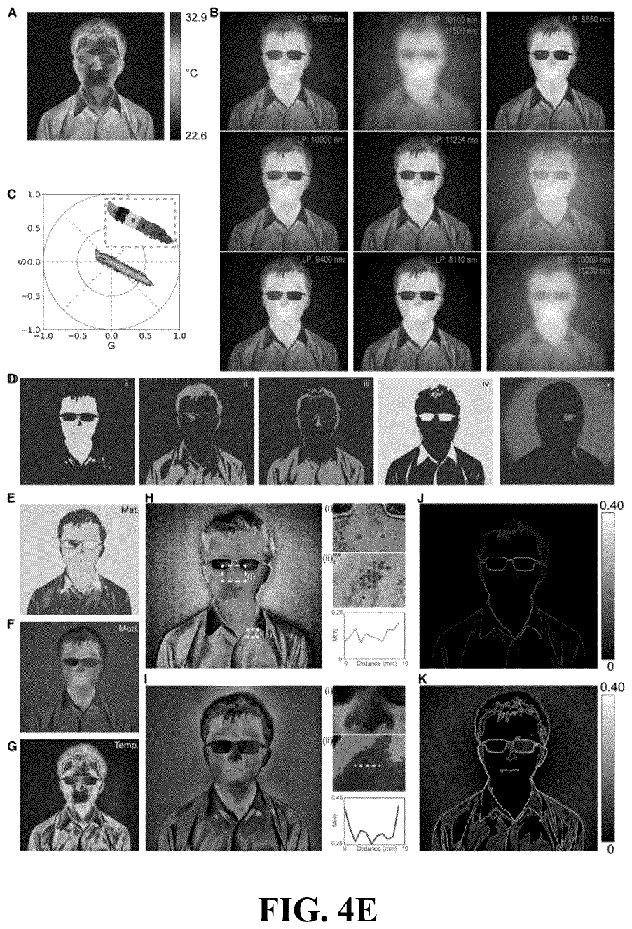

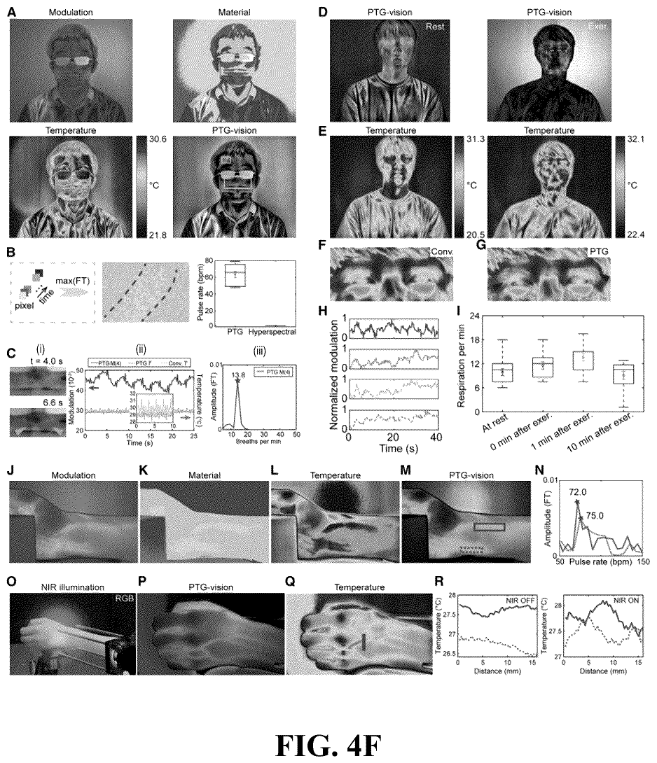

The PTG image generator 114, operatively coupled to the trained AI model 112, receives the material segmentation map 126 and the temperature map 128 from the model 112. The controller 106 is then configured to generate, via the PTG image generator 114, a phasor thermographic (PTG) image 130 by combining at least two of the texture modulation map 124 (e.g., as brightness), the material segmentation map 126 (e.g., as color hue), and the temperature map 128 (e.g., as saturation). The controller 106 is then configured to output the PTG image 130 (e.g., FIG. 4A, subpanel (h)), which can subsequently be used for health monitoring or medical diagnosis.

In the example shown in FIG. 1B, the controller 106 employs the clustering algorithm 132 and the thermal decomposition algorithm 134 to generate the material segmentation map 126 and the temperature map 128. Specifically, the controller 106 is configured to generate, via the cluster algorithm 132 (e.g., K-means clustering [35], [36]), the material segmentation map 126 by partitioning the phasors within the one or more phasor data 122 into the one or more clusters, where each cluster forms a segment of the material segmentation map 126. The controller 106 is then configured to generate, via the thermal decomposition algorithm 134 (e.g., implemented using Equations 3 and 4), the temperature map 128 having the plurality of temperature values, where each temperature value is computed using the emissivity values from the material segmentation map 126 and the texture values from the texture modulation map 124 (see Equations 7, 9, 11). The temperature map 128 is then used by the PTG image generator 114, in combination with the texture modulation map 124 and the material segmentation map 126, to generate the PTG image 130, as described in FIGS. 1A, 1C, and 1D.

Local Implementation. In the example shown in FIG. 1C, the controller 106 is implemented as a software or application on a computer 142 configured to communicatively operate with the sensor 102 via a local connection (e.g., a cable connection). In some embodiments, the PTG image 130 is generated (e.g., by the generator 114) and stored on the computer 142.

Cloud Implementation. In the example shown in FIG. 1D, the controller 106 is implemented as a software or application on a mobile device 144 that has a network interface configured to communicatively operate with the sensors 102a-102n via the network 146. In some embodiments, the PTG image 130 is generated (e.g., by the generator 114) and stored on the mobile device 144.

In some embodiments, the controller 106 is located in a cloud infrastructure that has a network interface configured to communicatively operate with the sensors 102a-102n via the network. In some embodiments, the PTG image 130 is generated and stored on the cloud infrastructure.

Noise Removal. In the examples shown in FIGS. 1A-1B, motion of the filters 104a-104n, caused by the actuator 116, can cause noises (e.g., motion artifacts) in the images 120. In some embodiments, prior to the thermal phasor transformation operation 108, the controller 106 is configured to remove the noises in the images 120 by (i) selecting a first filtered thermal radiation image of the images 120 as a fixed reference and (ii) aligning (e.g., by rotating, scaling, etc.) other filtered thermal radiance images of the images 120 with the first filtered thermal radiation image.

### Example Method

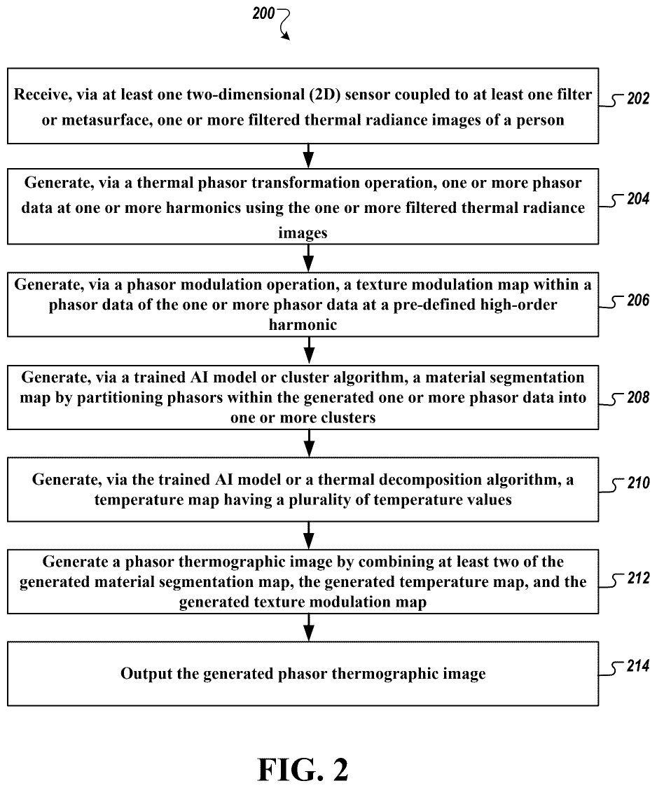

FIG. 2 shows an example method of hyperspectral thermographic analysis and imaging 200 (also referred to as thermal phasor analysis), in accordance with an illustrative embodiment. As shown, the method 200 includes receiving (202) receiving, via at least one two-dimensional (2D) sensor (e.g., 102, FIGS. 1A-1D) coupled to at least one filter (e.g., 104, FIGS. 1A-1B) or metasurface (e.g., 140, FIGS. 1C-1D), one or more filtered thermal radiance images (e.g., 120, FIGS. 1A-1D) of a person. The at least one sensor (e.g., 102, FIGS. 1A-1D) is configured to capture/acquire images (e.g., 120, FIGS. 1A-1D) of a thermal radiance emitted by the person and filtered by the at least one filter (e.g., 104, FIGS. 1A-1B) or metasurface (e.g., 140, FIGS. 1C-1D) at one or more predefined frequency bands (e.g., LWIR bands).

In some embodiments, the at least one filter (e.g., 104, FIGS. 1A-1B) includes a first filter and a second filter, each movable via an actuator during image capture/acquisition of the filtered thermal radiation (e.g., 118, FIGS. 1A-1i). The image acquisition, by the at least one sensor (e.g., 102, FIGS. 1A-1i), of the outputs (e.g., filtered thermal radiation 118) of the first filter at a first time instance and of the second filter at the second time instance, can collectively provide hyperspectral information across an electromagnetic spectrum for each pixel in the one or more filtered thermal radiance images (e.g., 120, FIGS. 1A-1).

The method 200 includes generating (204), via a thermal phasor transformation operation (e.g., 108, FIGS. 1A-1D) (e.g., implemented using Equations 1 and 2), one or more phasor data (e.g., 122, FIGS. 1A-1D) (e.g., plots, texture data) at one or more harmonics (e.g., 1^{st}, 2^{nd}, 3^{rd}, 4^{th}, etc.) using the one or more filtered thermal radiance images (e.g., 120, FIGS. 1A-1D). Each phasor data can represent characteristics of thermal radiance at the one or more predefined frequency bands. The method 200 includes generating (206), via a phasor modulation operation (e.g., 110, FIGS. 1A-1D), a texture modulation map (e.g., 124, FIGS. 1A-1D) within a phasor data of the one or more phasor data (e.g., 122, FIGS. 1A-1D) at a pre-defined high-order harmonic (e.g., 4^{th} harmonic). The generated texture modulation map (e.g., 124, FIGS. 1A-1D) can include texture values represented by the phasor data (e.g., 122, FIGS. 1A-1D).

The method 200 includes generating (208), via a trained AI model (e.g., 112, FIGS. 1A, 1C-1D) or cluster algorithm (e.g., 132, FIG. 1), a material segmentation map (e.g., 126, FIGS. 1A-1D) by partitioning phasors within the generated one or more phasor data (e.g., 122, FIGS. 1A-1D) into one or more clusters. The generated material segmentation map (e.g., 126, FIGS. 1A-1D) can include emissivity values of materials represented by the phasors. The method 200 includes generating (210), via the trained AI model (e.g., 112, FIGS. 1A, 1C-1D) or a thermal decomposition algorithm (e.g., 134, FIG. 1), a temperature map (e.g., 128, FIGS. 1A-1D) having a plurality of temperature values. Each temperature value in the temperature map (e.g., 128, FIGS. 1A-1D) can be computed using (i) the emissivity values from the generated material segmentation map (e.g., 126, FIGS. 1A-1D) and (ii) the texture values from the generated texture modulation map (e.g., 124, FIGS. 1A-1D) (see Equations 7, 9, 11).

The method 200 includes generating (212) a phasor thermographic image (e.g., 130, FIGS. 1A-1D) by combining at least two of the generated material segmentation map (e.g., 126, FIGS. 1A-1D) (e.g., as color hue), the generated temperature map (e.g., 128, FIGS. 1A-1D) (e.g., as saturation), and the generated texture modulation map (e.g., 124, FIGS. 1A-1D) (e.g., as brightness). The method 200 includes outputting (214) the generated phasor thermographic image (e.g., 130, FIGS. 1A-1D), where the output is subsequently employed for health monitoring or medical diagnosis.

In some embodiments, the generation (206) of the texture modulation map is based on phasor modulation within the phasor data at a 4^{th} harmonic.

During the generation (208) of the material segmentation map (e.g., 126, FIGS. 1A-1D), the partitioning of the phasors within the generated one or more phasor data (e.g., 122, FIGS. 1A-1D) into the one or more clusters can include (i) selecting one or more phasors as one or more cluster centers, (ii) partitioning phasors located within a predefined distance from the one or more cluster centers into one or more clusters, and (iii) assigning a value (e.g., color, sum of squared distances from each phasor to its center) to each of the one or more clusters, where each cluster can form a segment of the material segmentation map (e.g., 126, FIGS. 1A-1D).

The generation (210) of the temperature map (e.g., 128, FIGS. 1A-1D) can include (i) determining, via a material-emissivity library, an emissivity value for a given pixel in the one or more filtered thermal radiance images (e.g., 120, FIGS. 1A-1D), where the given pixel corresponds to a segmented material in the generated material segmentation map (e.g., 126, FIGS. 1A-1D), (ii) determining a lighting factor value (e.g., surface view factor V) for the given pixel in the one or more filtered thermal radiance images (e.g., 120, FIGS. 1A-1D), where the lighting factor for the given pixel corresponds to a segmented texture modulation in the generated texture modulation map (e.g., 124, FIGS. 1A-1D), and (iii) determining a temperature value for the given pixel in the one or more filtered thermal radiance images (e.g., 120, FIGS. 1A-1D) using the determined emissivity value and the determined lighting factor for the given pixel (see Equations 7, 9, 11). A plurality of determined temperature values for a plurality of pixels in the one or more filtered thermal radiance images (e.g., 120, FIGS. 1A-1D) can form the generated temperature map (e.g., 128, FIGS. 1A-1D).

In some embodiments, the trained AI model (e.g., 112, FIGS. 1A, 1C-1D) is a neural network model trained using.

### Example Thermal Phasor Analysis

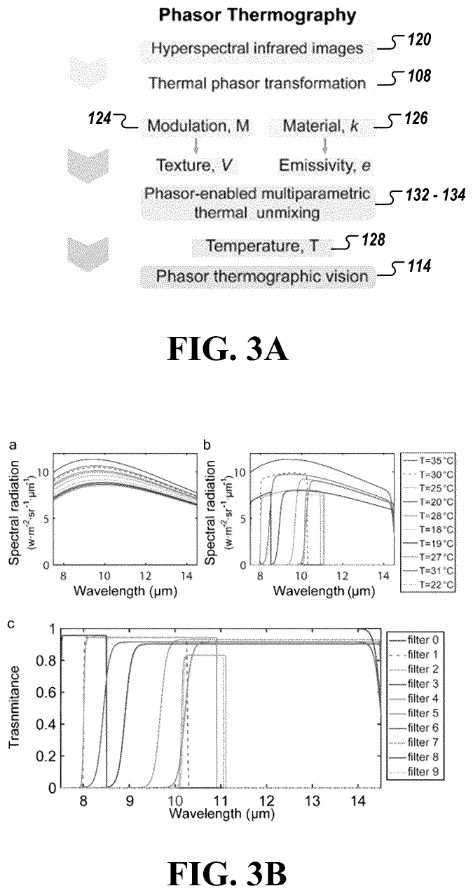

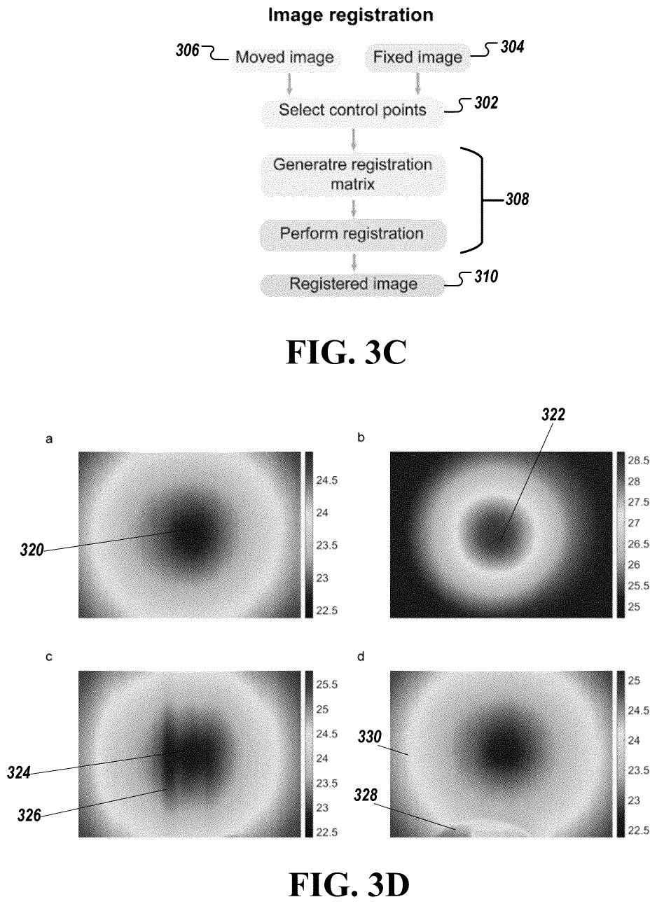

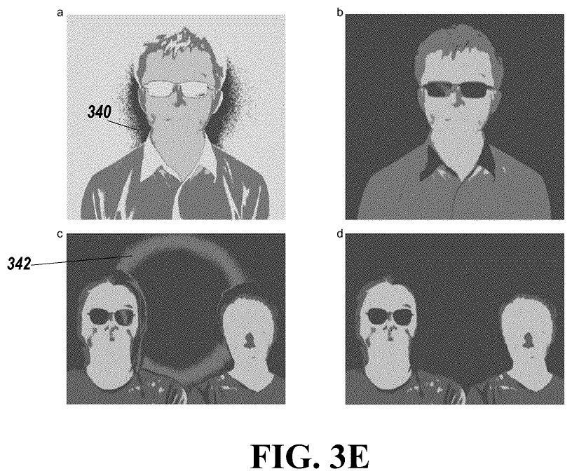

FIG. 3A shows an example operation flow of the exemplary thermal phasor analysis system and method, in accordance with an illustrative embodiment. The exemplary thermal phasor analysis is configured to enhance thermal imaging. As shown, the exemplary phasor analysis receives hyperspectral infrared images 120 (e.g., from the image registration and preprocessing operation in FIG. 3C), which are previously registered and reorganized into a spatial-spectral-temporal dataset (e.g., a four-dimensional (4D) dataset) to improve temporal resolution, then proceeds to the thermal phasor transformation 108.

Thermal Phasor Transformation (108). The components of the k^{th} order harmonic phasors can be defined as, Hₖ=Gₖ+iSₖ. The phasor components G and S at the k^{th} harmonics can be defined per Equations 1 and 2.

$${G}_{k} = \frac{{\sum }_{n = 1}^{N} I ( {Δλ}_{n} ) cos ( \frac{2 π nk}{K} )}{{\sum }_{n = 1}^{N} I ( {Δλ}_{n} )} \qquad ( Eq . 1 )$$

$${S}_{k} = \frac{{\sum }_{n = 1}^{N} I ( {Δλ}_{n} ) sin ( \frac{2 π nk}{K} )}{{\sum }_{n = 1}^{N} I ( {Δλ}_{n} )} \qquad ( Eq . 2 )$$

In Equations 1 and 2, K is the number of frequency channels of phasor transformation, equaling the number of hyperspectral channels N (e.g., K=10). As the phasor transformation 108 is grounded on the discrete Fourier transformation (e.g., K=N) [27], [29], [60], due to the periodicity of trigonometric functions, higher-order harmonics (e.g., k>N−1) can be repetitions of the first N harmonics. The phasors at zero-harmonic (e.g., k=0) can also be denoted as the mean hyperspectral value. Intensity I(Δλₙ) denotes thermal radiation obtained from the n^{th} infrared spectral waveband λₙ(n=1, 2, 3, . . . , 10). Pixel-wise thermal phasor transformation can be applied to the thermal intensity across the wavebands (e.g., 10 wavebands) in the long-wave infrared (LWIR) spectrum. Specifically, the thermal phasor transformation 108 can be achieved by first applying a discrete Fourier transform to the intensity of each pixel in the hyperspectral infrared thermal image stack 120. Then, based on Equations 1 and 2, phasors at each pixel can be calculated, including the phasor components G and S. After the phasor transformation 108, the phasors can be analyzed and visualized, and k-means clustering of the phasors can be performed (e.g., using Python 3.11 software).

K-Means Clustering (132). Unique thermal fingerprints in a phasor domain can indicate material categories depending on the infrared emissivity. At the fourth harmonic, the phasors can be separated by modulation, providing texture details in a modulation map 124. The phasor analysis can use k-means clustering (e.g., 132, FIG. 1B) to partition the phasors into a number of clusters based on underlying patterns or structure in the phasor data. K-means clustering (e.g., 132, FIG. 1B) is an unsupervised machine learning algorithm that can group similar points by minimizing the sum of squared distances between phasor points and their respective cluster centers. Each cluster can correspond to a material identified by its unique thermal fingerprints. Mapping the points within a specific radius around the centers obtained from the k-means clustering back to the mean hyperspectral image and coloring each cluster can yield a material map 126.

The phasor analysis can use an elbow method to determine the optimized number of clusters for k-means clustering [5′], [6′]. The elbow method can run k-means clustering on the phasor dataset at a specific harmonic for a range of cluster counts and calculate the average score for all clusters (e.g., the sum of squared distances from each phasor point to its assigned center, referred to as inertia). K-means clustering is configured for clustering the phasor points at the fourth harmonic, and the phasor clusters can represent the material types.

High-Order Harmonic Phasor Analysis. Decomposing thermal radiation (e.g., 134, FIG. 1B) into harmonics can be based on the Fourier transform, a mathematical technique that decomposes a signal into its constituent frequencies (referred to as harmonics). A phasor modulation M (defined by Equation 3) and a phase θ (defined by Equation 4) at various harmonics (e.g., at the k^{th} harmonic) can provide information about the thermal radiation of the imaging scene at different frequency ranges.

$$M ( k ) = \sqrt{{S}_{k}^{2} + {G}_{k}^{2}} \qquad ( Eq . 3 )$$

$$θ = arccos ( G / M ) = arcsin ( S / M ) \qquad ( Eq . 4 )$$

The first phasor harmonic can be used to interpret the hyperspectral data in hyperspectral and fluorescence lifetime microscopy. The wavelength for the radiation intensity peak, denoted as Amax, can follow Wein's displacement law (e.g.,

$$( e . g . , {λ}_{max} ∼ \frac{1}{T} ) .$$

Thus, thermal phasor clusters can be close together because of overlapping wavebands for objects at room temperature, unlike hyperspectral fluorescence microscopy or fluorescence lifetime imaging [26], [28]. Thermal phasors at the fourth-order harmonic can give texture details of the imaging object. The improved texture resolution at high harmonics can be explained by the relationship between temperature and thermal radiation energy (e.g., the Stefan-Boltzmann law) and the phase regulation of high-harmonic exponentials.

Spectral thermal radiation B_{λ}(T) at a specific temperature can follow Planck's law of blackbody radiation in units of energy per unit of time, per unit of solid angle, and unit of wavelength (w·m⁻²·sr⁻¹·m⁻¹) can be defined per Equation 5.

$${B}_{λ} ( T ) = \frac{2 {hc}^{2}}{{λ}^{5}} \frac{1}{{e}^{( \frac{hc}{λ {k}_{B} T} )} - 1} \qquad ( Eq . 5 )$$

In Equation 5, T is the absolute temperature in Kelvin, h is Planck's constant, λ is the wavelength, c is the speed of light, and k_{B} is the Boltzmann constant. If the temperature T shifts from T to αT, where α is a dimensionless number, the spectral radiance at a specific wavelength can be a fraction of the spectral radiation scaling, as shown in Equation 6 [61].

$${B}_{λ} ( α , T ) = {α}^{4} {B}_{λ} ( αλ , T ) \qquad ( Eq . 6 )$$

The scaling per Equation 6 illustrates the superlinearity of blackbody radiation, facilitating integration to be commutative with the Fourier transform. Integrating the spectral thermal radiation from Planck's law can provide the total thermal energy E(T)=e_{λ}σT⁴ (e.g., Stefan-Boltzmann law) for a black body. Considering the direct radiation of a gray body (e.g., objects may behave as gray bodies with an emissivity e_{λ} between 0 and 1), scattering upon the texture of a diffusive surface, and the reflection upon a smooth surface, the thermal radiation energy can be defined per Equation 7.

$$E ( T ) = \int B ( λ , T ) d λ = {e}_{λ} σ {T}^{4} + ϕ ( {Ra}_{s} , X ) \qquad ( Eq . 7 )$$

The term φ(Raₛ, X) in Equation 7 is the reflection and the scattering from the ambient environment, including the noises from the filter wheel and the thermal camera (Narcissus effect), which can depend on both the surface texture X and the surrounding environment radiation. The phasor transformation's intrinsic is the Fourier transform of the hyperspectral thermal signals. The thermal radiation at the fourth harmonics can eliminate random scattering from small nonuniform surrounding radiations. The noise and scattering from the surrounding environmental heat sources can be reduced at the fourth harmonic. The direct thermal radiation energy through an infrared (IR) filter with number n can be defined as, E(n, T)=σe_{λ}Tₙ⁴, neglecting the thermal radiation reflected or scattered from the environment. Thus, the discrete Fourier transform at the fourth harmonic of E(n, T) can be defined per Equation 8.

$$ℱ ( E ( n , T ) , k = 4 ) = {\sum }_{n = 0}^{N - 1} ( σ {e}_{λ} {T}_{n}^{4} ) {e}^{- i \frac{2 π nk}{N}} = σ {\sum }_{n = 0}^{N - 1} {( {{e}_{λ}}^{\frac{1}{4}} {T}_{n} \cdot {e}^{- i \frac{2 π n}{N}} )}^{4} \qquad ( Eq . 8 )$$

Therefore, due to the inherent orthogonality of the Fourier series and phase regulation of the high-order exponentials, the phasor at fourth-order harmonics (e.g., k=4) can be more aligned with the theoretical exponential form of thermal radiation energy within a specific infrared waveband. In other words, phasors at fourth-order harmonics enlarge the difference in the modulation (denoted as M) for direct thermal emission from the object, which is the primary one proportional to the T⁴. The extensive modulation variation can reveal texture details (e.g., surface view factor V), in the modulation map 124, that may otherwise be obscured by intense thermal radiation (e.g., ghosting effect).

The emissivity of different materials can be independent of the temperature [21]. At a fixed thermal radiation intensity, the thermal sensitivity of a thermal camera can be related to the material emissivity by

$$\frac{dT}{{dT}_{ca}} ∝ {( \frac{{e}_{λ}}{{e}_{λ , ca}} )}^{- 1 / 4} [ 21 ] ,$$

where e_{λ} and T are the realistic emissivity and temperature, while e_{λ,cα} and T_{cα} are the emissivity and temperature from the thermal camera, respectively. The actual emissivity can vary with materials, though it can be a constant for thermal cameras. After thermal phasor transformation 108, the phasor energy can peak at the fourth harmonic, leading to a modulation range that indicates textures. The phasor modulation 124 can also reflect thermal variations due to material differences, facilitating better separation of materials (denoted as k) with different emissivities (denoted as e).

Phasor-Enabled Multiparametric Thermal Unmixing (132-134). The thermal radiation intensity within a specific waveband can be defined per Equation 9 [14].

$${I}_{t} ( Δ λ , T , {e}_{λ} , {S}_{λ} ) = {\int }_{Δ λ} {e}_{λ} {B}_{λ} ( T ) + ( 1 - {e}_{λ} ) {S}_{λ} \qquad ( Eq . 9 )$$

In Equation 9, e_{λ} is the emissivity of the material and S_{λ} represents the scattering of environmental radiation from the object's surface, as defined by Equation 10.

$${S}_{λ} = {\sum }_{β} {V}_{β} {R}_{β λ} . \qquad ( Eq . 10 )$$

In Equation 10, the environmental radiation, denoted as R_{βλ}, and surface view factor, denoted as V_{β}, denoting the geometric surface normal, can contribute to scattering radiation Sa. The view factor V_{β} is represented by the normalized modulation at the fourth harmonic M*(4) through thermal phasor transformation and analysis, i.e., ranging from 0 to 1, precisely capturing the texture details. Material segmentation 126 can be achieved by the k-means clustering (e.g., 132, FIG. 1B) of the thermal phasors. Through the initial texture-emissivity-temperature decomposition (non-linear regression of Equation 9), the emissivity values for each material can be estimated by minimizing the square loss based on the material emissivity library. By encoding the modulation classification 124 and material classification 126 as texture (view factor V_{β}) and emissivity e_{λ}, respectively, into the texture-emissivity-temperature decomposition algorithm (e.g., 134, FIG. 1), the temperature map 128 can be obtained from variations in material and texture.

Realistic thermal imaging situations can be complex and noisy, with multiple heat sources, as the thermal camera captures the thermal signal by converting all thermal photons into the heating of the camera and the electronic signal. The phasor-enabled multiparametric thermal reconstruction algorithm (see Table 1) does not impose stringent requirements on filter wavebands or thermal cameras, provided that thermal radiation differences arising from variations in texture, emissivity, and temperature can be captured through at least four spectrally distinct wavebands. In the nonlinear regression algorithm for thermal decomposition (e.g., 134, FIG. 1B) used in thermal unmixing (decomposition) of thermal radiation, which has three variables (e.g., texture, temperature, and material), at least four spectral wavebands may be required [24]. This ensures the formation of a well-defined optimization problem, facilitating temperature estimation while accounting for variations in material and texture across the imaging scene.

Incorporating additional LWIR wavebands can enhance the performance of phasor thermography (PTG) and improve the accuracy of thermal reconstruction. More wavebands and higher spectral resolution of the filters can enhance PTG performance, enabling improved material classification, greater sensitivity to subtle material variations, and more accurate temperature measurements. While inappropriate selection or limited spectral resolution in wavebands can lead to suboptimal performance, the thermal phasor method can achieve greater separability of phasors at higher harmonics, thereby facilitating material segmentation and texture extraction. A material library specific to imaging scenes should be developed before applying PTG processing 114 to hyperspectral imaging data 120 to enhance the accuracy of emissivity assignment, thereby improving the performance of the phasor-enabled multiparametric thermal unmixing algorithm (e.g., implementing 132-134) and temperature measurement. Incorporating a scene-specific material-emissivity library can enable precise analysis and robust performance, particularly in complex thermal imaging environments where materials can exhibit similar thermal properties.

Phase-therographic-vision (PTG-vision) Rendering (114). The hue-saturation-brightness (hsv, hue-saturation-value) colorization can be used to fuse texture, material, and temperature into PTG-vision 114. The materials can be depicted in various hues, while temperature and texture modulation can be represented by saturation and brightness (value), respectively. This method can enhance the visual differentiation of materials, providing detailed and subtle variations in temperature and texture. This way, the PTG-vision 114 can be obtained as the RGB image in bright daylight.

### Example Phasor-Enabled Multiparametric Thermal Unmixing

Thermal Radiation Modeling. The total thermal radiation captured by a thermal camera, denoted as I_{cam} can include direct thermal radiation and the reflection of environmental radiation, including specular reflection and diffusive scattering from the object's surface. The total thermal radiation I_{cam} can be the integration of the spectral radiance over the specific waveband Δλ and be defined by Equation 11.

$${I}_{cam} ( Δλ , T , e , {S}_{λ} ) = {δ}_{f} {\int }_{Δ λ} ( {eB}_{λ} ( T ) + ( 1 - e ) {S}_{λ} ) . \qquad ( Eq . 11 )$$

In Equation 11, e is the emissivity of the material, and S_{λ} (defined by Equation 10) represents the scattering of environmental radiation from the object's surface. The environmental radiation R_{βλ} and surface view factor V_{β} denoting the geometric surface normal, can contribute to scattering radiation S_{λ}. Parameter δ_{f}, used to connect the theoretical and realistic thermal radiation, considers the camera response δ_{cam} (see FIG. 4A, subpanel (c)) and transmittance τ* from the filter wheel δ_{f}=δ_{cam}τ*.

FIG. 3B shows an example spectral thermal radiation through multiple infrared filters. In FIG. 3B, subpanel (a) shows a spectral thermal radiation following Planck's law of blackbody radiation. In FIG. 3B, subpanel (b) shows spectral thermal radiation profiles after the spectral thermal radiation being transmitted through infrared filters at various temperatures, denoted as T (e.g., T=35, 30, 25, 20, 28, 18, 19, 27, 21, 22° C.). In FIG. 3B, subpanel (c) shows transmittance profiles approximated by a hyperbolic tangent function for the wavebands, e.g., from one with no filter (filter 0) and nine infrared filters (filter 1-9).

Each pixel from the hyperspectral image stack (e.g., 120, FIGS. 1A-1D) can include spectral radiation over ten wavebands, which are all a fraction of the blackbody radiation (see FIG. 3B, subpanels (a)-(b)). To model thermal radiation, the non-uniform transmittances, denoted as τ*, for the wavebands can be approximated by a hyperbolic function (see FIG. 3B, subpanel (c)). The product of the integrals of the two parameters δ_{cam} and τ* over the wavebands can be used to approximate the factor δ_{f} (see Equation 11).

In a phasor-enabled multiparametric thermal unmixing algorithm (see Table 1), a modulation map (e.g., 124, FIGS. 1A-1D) indicating the surface texture can be encoded as the lighting factor Vg in the scattering radiation term (see Equation 10). The unmixing algorithm can regulate the environmental radiation by assuming two primary heat sources. The environmental radiation R_{βλ} can be approximated by two primary surrounding heat sources, e.g., stainless steel (emissivity of 0.59) and black curtain (emissivity of 0.77). Thus, the scattering of environmental radiation can be defined as S_{λ}=VR_{1λ}+(1−V)R_{2λ}, where the view factor V_{β} is V and 1−V for the two primary heat sources.

Texture and Emissivity Assignment. In Equation 11, with the background radiation modeled by two primary radiation sources, the total thermal radiation can have three variables (e.g., texture indicator V, emissivity e, and temperature T). The view factor V, which contains the texture details, can influence the thermal radiative signals analyzed via phasor modulation, thereby affecting the amplitudes of the phasors used in thermal phasor analysis. The view factor V is represented by the normalized modulation at the fourth harmonic M*(4), which can differentiate texture across a wide range through thermal phasor transformation, ranging from 0 to 1, thereby capturing detailed texture variations. A texture map (e.g., in the phasor data 122) obtained from the phasor modulation is not affected by radiation from the surrounding environment, as direct emission is stronger than scattering and noise, demonstrating the robustness of the phasor modulation described herein for texture extraction.

Non-Linear Regression for Thermal Decomposition (134). Non-linear regression can first be used to decompose these three parameters, T, e, V, assuming that some materials exist in the scene and each material corresponds to one emissivity (e.g., material-emissivity library [7′], [8′]). By iteratively processing each material in the material library, the losses for the non-linear regression can be calculated by fitting the temperature T and texture V for each material. The emissivity/material type can be identified as the one with the smallest loss (emissivity estimation). The material map (e.g., 126, FIGS. 1A-1D) can provide the segmentation of different materials in the scene. By assigning the corresponding emissivity for each material segmentation based on the material-emissivity library and emissivity estimation, each pixel can have the emissivity e. In the thermal radiation model, emissivity can be constant, representing the average value across the spectrum.

A texture map (e.g., in the phasor data 122) can be fused with the modulation map (e.g., 124, FIGS. 1A-1D) when the ambient radiation or thermal noises are intense to get improved texture extraction [8′]. Fusing the material channel as color hue, temperature as saturation, and texture modulation as brightness can enable phasor thermographic vision, which can see temperature, texture, and material through darkness.

The thermal radiation from the environment can depend on the experimental setup and the surrounding environment. To obtain the temperature, an emissivity value assignment based on the material map (e.g., 126, FIGS. 1A-1D) can be incorporated into the phasor-encoded multiparametric thermal reconstruction algorithm (see Table 1). Thus, the phasor-informed thermal unmixing is robust against environmental variations.

Table 1 summarizes the steps of an example phasor-enabled multiparametric thermal unmixing algorithm (e.g., implementing 132-134, FIG. 1B).

TABLE 1
Phasor-enabled multiparametric thermal unmixing algorithm

| | |
|---|---|
| Step 1 | The algorithm performs (i) phasor transformation and analysis to obtain material |
| | segmentation based on k-means clustering and (ii) texture extraction based on the |
| | normalization of the modulation map at the 4^{th} harmonic. |
| Step 2 | The algorithm evaluates the scattering from the environmental radiation S_{λ}(V_{β}, R_{βλ}). |
| | Specifically, the algorithm approximates the environmental radiation R_{βλ} using two |
| | primary surrounding heat sources. The algorithm can set the temperature of the |
| | surrounding environment and the primary heat source, as well as the emissivity of the |
| | two sources in the thermal radiation model. |
| Step 3 | The algorithm employs non-linear regression (see Equation 9) to decompose the thermal |
| | radiation I_{cam}(Δλ, T, e, S_{λ}(V_{β})) and estimate the temperature (Tₑₛₜ), emissivity (eₑₛₜ), |
| | and texture (Vₑₛₜ) for each pixel. By iterating through the material library, the |
| | algorithm obtains the emissivity values eₑₛₜ by minimizing the square loss using |
| | hyperspectral thermal radiation data from filters (e.g., Δλ₁ to Δλ₁₀) for each pixel in the |
| | imaging scene. |
| Step 4 | The algorithm assigns the emissivity e corresponding to one material to all pixels in one |
| | segmentation in the material map obtained in step 1. The algorithm uses the texture map |
| | from step 1 as the surface view factor V for one heat source. |
| Step 5 | The algorithm embeds e and V from Step 4 into the non-linear regression estimator for |
| | I_{cam}(Δλ, T)) with one variable (T) to obtain temperature, using material and texture |
| | variations in the imaging scene. |

### Example Image Registration and Preprocessing

FIG. 3C shows an example image registration and preprocessing of hyperspectral thermal images, which are subsequently used for the phasor analysis in FIG. 3A.

Mechanical motion of the filters (e.g., 104, FIGS. 1A-1B) can introduce unwanted motion into the hyperspectral images (e.g., 120, FIGS. 1A-1B). The unwanted motion can be addressed by registering each hyperspectral image stack (e.g., 120, FIGS. 1A-1B), which comprises 10 sequential spectral images, one from each filter position. The infrared image without a filter (e.g., 104, FIGS. 1A-1B) can be selected (306) as the fixed reference 304 (control point), and the nine other images 306 can be registered (308) to the reference 302 to generate registered images 310. No additional denoising processes are applied to the hyperspectral image stack (e.g., 120, FIGS. 1A-1B), except for the removal of physical noises in the image stack.

### Example Physical Thermal Noises Removal

Physical Noises. Thermal noise can arise from the inner heating of the thermal camera (e.g., the Narcissus effect), the filter wheel, and surrounding heat sources. Noises from heat sources in the imaging scene and experimental setup are referred to as physical noises, as they arise from physical objects, such as the heating of the inner thermal camera. Physical noises can affect the observation of an object, such as a human face. The thermal radiation from the surrounding environment and the scattering from the object can be complex when multiple objects are present.

FIG. 3D shows example physical noises and their interaction with various objects (e.g., chair, curtain) in the environment. In FIG. 3D, subpanel (a), without any objects in view, the filter wheel's diaphragm effect and the Narcissus effect can cause a non-uniform temperature distribution, resulting in a lower-temperature circle 320 at the center of an image frame. In FIG. 3D, subpanel (b), placing the gold mirror in front of the thermal camera lens allows thermal radiation from inside the camera to be detected, causing the inner circle 322 to be hot, because gold reflects 99% of infrared light. In FIG. 3D, subpanel (c), with a black curtain 326 in the image frame, the colder inner circle 324 can be distorted and mixed with the black curtain 326, which may be at a lower temperature than the filter wheel. In FIG. 3D, subpanel (d), when the top tip of the chair back 328 is within the image frame, the hotter outer circle 330 is distorted by the higher chair temperature. The temperature distribution and texture of the wavy black curtain and chair are mixed with physical thermal noise, raising the temperature relative to the actual temperature. To determine an object's true temperature or texture, any physical thermal noises should be removed from the thermal images.

Thermal-Fingerprint-Based Denoising in Phasor Domain. From the above-discussed thermal phasor analysis, the classification of different materials, including physical noise, can be obtained. By replacing the noise component with background radiation, thermal images can be denoised without the physical denoising of thermal images using blackbody sources (e.g., a curtain).

FIG. 3E shows an example denoising of thermal images based on the material classification in the thermal phasor domain (also referred to as thermal-fingerprint-based denoising). In FIG. 3E, subpanel (a), physical noises form a material component in the phasor domain, resulting in a circle 340 in the background of the scene. Removing this noise component can result in clear, precise material classification, providing accurate identification of the materials present in the scene. Similarly, in FIG. 3E, subpanels (c)-(d), the physical noise 342 is removed in the thermal phasor domain. The denoising process can facilitate accurate material classification, ensuring that individuals' thermal characteristics are accurately depicted.

### Example Artificial Intelligence (AI) and Machine Learning (ML) Models

Machine Learning. In addition to the machine learning features described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

A study was conducted to develop and evaluate an experimental hyperspectral phasor thermography system (also referred to as a phasor thermography (PTG) system) configured to transforming infrared (IR) thermal radiation into visible images (e.g., PTG image) using (i) full-harmonics thermal phasor transformation and (ii) a trained AI model or a combination of clustering operation and thermal decomposition, as described in relation to FIGS. 1-3.

Experimental Setup. FIGS. 4A-4B each shows the same experimental hyperspectral phasor thermography system in the study. In FIG. 4A, subpanel (a), the experimental hyperspectral thermography system included a forward-looking infrared (FLIR) camera (e.g., FUR A615sc), equipped with a motorized wheel, having nine long-wave infrared (LWIR) filtered channels (e.g., 8-14 μm) and an unfiltered channel. In FIG. 4A, subpanel (b), the experimental system sequentially captured thermal radiation images from each LWIR band, which included direct blackbody emission and environmental scattering, reflecting the integral of the total spectral thermal radiation over the waveband. The acquired hyperspectral image stack underwent a thermal phasor transformation, generating phasor plots for 10 harmonics (e.g., H₀ through H₉, associated with the number of wavebands). Each phasor plot provided a distinct thermal signal fingerprint that encapsulated the unique characteristics of the thermal data at different frequency bands. However, at room temperature (e.g., 20° C.), the wavebands substantially overlapped within the LWIR spectrum (see FIG. 4A, subpanel (b)), leading to clustered phasors at their 1^{st} harmonic, the domain typically used for optical phasor analysis [28] (see FIG. 4A, subpanel (c)). The proximity of phasors corresponded to packed, less separable thermal signatures across hyperspectral wavebands under ambient thermography conditions.

In FIG. 4B, subpanel (a), the study used a 10-channel hyperspectral infrared imaging system for the experimental system to capture thermal images across multiple wavebands. The experimental system included a FLIR A615sc thermal camera and a ten-position motorized filter wheel. The FLIR A615sc thermal camera had a resolution of 640×480 pixels and a maximum frequency of 50 Hz. The thermal camera (e.g., FLIR A655sc) had a thermal sensitivity of 50 millikelvins and an accuracy of ±2° C. The thermal camera (e.g., FLIR A655sc) was an uncooled microbolometer (e.g., a photon-thermal detector). The camera converted infrared radiation into an electrical signal by heating an absorbing material, thereby changing the material's electrical resistance and generating an electronic signal used to display the image. In FIG. 4B, subpanel (b), the response curve of the thermal camera shows the camera's sensitivity and performance across different waveband ranges. In FIG. 4B, subpanel (b), the motorized filter wheel used in the setup was a Zabor X-FWR06A-E02-FH0625 model, which provided an accuracy of 0.4°. The minimum time to change adjacent optics was 57 milliseconds. Nine infrared filters were loaded into the 10-position filter wheel, and the wavebands were SP-10650 nm, BBP-10100-11500 nm, LP-8550 nm, LP-10000 nm, SP-11234 nm, SP-8670 nm, LP-9400 nm, LP-8110 nm, BBP-10000-11230 nm, denoted as filter 1, filter 2, . . . , filter 9, respectively. The image captured without using any filter was denoted as filter 0. For phasor thermography to display veins on the back of the hand, infrared light illumination at 850 nm enhanced the contrast between the subsurface blood vessels and surrounding tissues. This technique improved the visibility of vascular structures by highlighting the thermal differences. In FIG. 4B, subpanels (d)-(e), the infrared light source included an infrared LED (e.g., OSRAM LZ4-00R40800R408) collimated by a condenser lens (e.g., Thorlabs ACL50832U-B). The study used a maximum current of 0.5 Ampere.

The study initially defined the phasor energy P_{(x,y)}(k) at the k^{th} harmonic as P_{(x,y)}(k)=[M_{(x,y)}(k)]², where M_{(x,y)}(k) denotes the phasor modulation, e.g., the magnitude of a phasor Hₖ=Gₖ+iSₖ, at the k^{th} harmonic for a given pixel at location (x, y). This definition is consistent with formulations in the Fourier domain, such as Parseval's theorem [33], ensuring that the energy remains positive and maintains a quadratic relationship with modulation. In FIG. 4A, subpanel (d), within the phasor domain, the phasor energy at each pixel reached its maximum at the 4^{th} harmonic (k=4). On the 4^{th} harmonic, the phasors underwent phase regulation due to their 4^{th}-order complex exponential in the Fourier transform, aligning their phase with that of thermal energy, which was proportional to T⁴, per the Stefan-Boltzmann law [34].

The analysis of full-harmonic phasor energy pinpointed high-energy harmonics to enhance detection sensitivity and facilitated deeper insights into the thermal characteristics. First, in FIG. 4A, subpanel (e), the extensive variation in modulation, indicated by the high phasor energy at the high-order harmonic, facilitated accurate, high-clarity retrieval of the object's texture. Next, the phasor analysis led to the formation of distinct, resolvable phasor clusters, particularly arranged quasi-linearly along the diagonal quadrants. This arrangement was crucial for material classification using k-means clustering [35], [36], effectively identifying the emissivity variations of the materials under investigation (see FIG. 4A, subpanel (f)). Lastly, the material classification allows for distinguishing components associated with ambient noise, which remained a challenge for current thermal imaging (see FIG. 4A, subpanel (f), and FIGS. 3D-3E). The distinct and representative thermal fingerprints within the full-harmonic phasor domain facilitated an accurate and rapid material classification, texture extraction, and the denoising of thermal images.

Hyperspectral Thermal Imaging. The study captured one thermal image frame after changing one filter, which took 0.2 s per frame, reducing the effective frame rate to 0.5 Hz for 10 frames of the hyperspectral images. The experimental setup was in a laboratory environment, with standard surroundings, including a chemical hood and an incubator. The laboratory was maintained at a constant temperature of 21(±2) ° C. by a central air conditioning system.

Phasor Thermography: Phasor-Enabled Multiparametric Thermal Unmixing. Ambient room environment and complex thermal radiation from surrounding sources induced challenges for decomposing physical attributes (e.g., temperature, emissivity, texture modulation) from hyperspectral thermal radiation. This complexity arose from the magnitude of the proximity between the thermal emissions of various room-temperature heat sources and those of the apparel and human body (e.g., at 37° C.). Using thermal phasor analysis, the study implemented a phasor-enabled thermal unmixing algorithm (see Table 1) that generated a temperature map by incorporating material classification and texture modulation derived from the phasor analysis (see FIG. 4A, subpanel (g)). The algorithm (see Table 1) unmixed temperatures close to the expected values with improved accuracy. Furthermore, to create multiparametric thermal images, the study generated phasor thermographic vision by displaying material classification as color hue, temperature as saturation, and phasor modulation as brightness (see FIG. 4A, subpanel (h)). As a result, integrating hyperspectral thermal phasor analysis, phasor-enabled thermal unmixing, and phasor thermographic vision provided a passive, noninvasive, high-resolution PTG system (e.g., the experimental system) that effectively discerned temperature, texture modulation, and material characteristics under a variety of conditions, enabling broad biomedical applications, including vital signs detection (see FIG. 4A, subpanel (i)).

Spectral Resolution for Physiological Feature Detection. Increasing the number of filters or using advanced hyperspectral imaging methods achieved higher spectral resolution. In body temperature detection, incorporating more spectral channels across the LWIR spectrum enhanced the phasor-enabled thermal unmixing algorithm (see Table 1). The phasor-enabled thermal unmixing algorithm, grounded in nonlinear regression and serving as a statistical estimator [14], [24], led to more accurate temperature evaluation. In the phasor domain, the thermal signals, specifically the modulation of phasors, were enlarged at specific frequency ranges, such as at the fourth harmonic. In the study, respiration rate and pulse/heart rate were captured using high-harmonic phasor analysis for image processing in the room environment. Including additional spectral channels, which offered increased spectral resolution, enhanced subtle material segmentation, benefiting the identification of regions of interest and physiological analysis, such as pathological segmentation [30], [32]. A higher temporal resolution of the thermal detector (e.g., thermal camera), along with increased image frequency, enhanced the accuracy and reliability of vital sign detection, including respiration and pulse rate measurements, enabling more precise tracking of subtle temporal physiological variations. Furthermore, the increased spectral resolution with more filters may facilitate the detection of other vital signs, such as metabolic rate [62], thereby broadening the potential medical and physiological applications of PTG [29], [30], [32].

Computational Requirements. The phasor-enabled multiparametric thermal unmixing algorithm, which constituted the time-consuming part of the experimental system, had a computational complexity of O(x×y×N), where x and y are the dimensions of the image, and Nis the number of wavebands. The unmixing algorithm was applied on a per-pixel basis, resulting in a computational cost that scaled proportionally with the image size (e.g., the total number of pixels). Based on gradient descent non-linear regression, the experimental system exhibited a computational complexity proportional to the number of data points, specifically the number of wavebands (N). The computation was performed using a parallel pool in MATLAB on a local computer with a 12th Gen Intel Core i7-12700K processor operating at 3.60 GHz. Image acquisition was performed on a local computer with an Intel Xeon Gold 6140 CPU operating at 2.29 GHz. For the human upper-body imaging scenario, the phasor transformation of a 500-image video at 5 Hz in MATLAB required CPU processing time on the order of minutes. The phasor analysis and visualization in Python 3.11 took less than 1 s to process. The algorithms on the local computer processed videos, completing thermal unmixing for a 500-image video within 5 hours, after the initial phasor-enabled multiparametric thermal unmixing for the one-time emissivity assignment. This demonstrated the computational efficiency of the experimental system and its practicality for processing large datasets promptly.

The experimental system could be further enhanced by integrating high-performance computing hardware (e.g., parallel processing with multiple processors and high-performance cluster computing), which would improve computational efficiency and enable real-time processing and high-speed imaging. This improvement makes the experimental system efficient and adaptable for various practical applications, including dynamic monitoring and rapid diagnostics in biomedical and industrial settings.

Characterization of Phasor Thermography. FIG. 4C shows a characterization of the experimental system with phantom and botanical specimens. FIG. 4D shows the emissivity spectra of (i) the resins forming a phantom hand skeleton, (ii) the flowing components, including fresh and dry petals and leaves, and (iii) obtained from an emissivity library.

To characterize the experimental system, the study first imaged a 3D-printed human hand phantom, including bones made of rigid, opaque photopolymer (e.g., Vero), with tendons and muscles, both having flexible rubber-like photopolymer (e.g., Agilus) (see FIG. 4C, subapenel (a), and FIG. 4D). In FIG. 4C, subpanel (b), the state-of-the-art thermal image displayed the total thermal radiation encompassing direct emissions from the target, environmental scattering, and noises at a constant emissivity across the entire scene. In FIG. 4C, subpanels (c)-(e), the experimental system acquired the hyperspectral image stack, performed thermal phasor analysis, and generated the modulation maps for the five independent harmonics (e.g., k=1 to 5). Hyperspectral thermal features were used, and the 4^{th} harmonic exhibited a more extended phasor distribution, allowing for the extraction of detailed textures, consistent with the full-harmonic phasor energy model (see FIG. 4C, subpanel (d), and Equation 3). In FIG. 4C, subpanel (d), the S components were all zero in the 5^{th} harmonic due to the characteristics of the trigonometric functions for hyperspectral channels. In FIG. 4C, subpanel (f), using the entire hyperspectral image stack, the 4th-harmonic results exhibited a 5-fold amplification in modulation depth (e.g., phantom texture extraction) compared to the 1^{st}-harmonic phasor analysis. The experimental system performed k-means clustering on the modulation maps and obtained material classification that included two distinct photopolymers and the background with two groups of ambient radiations, showing increased accuracy and clarity using the high-order harmonic phasors (see FIG. 4C, subpanels (g)-(h)), and FIGS. 3D-3F). In FIG. 4C, subpanels (a) and (h), the unmixed thermal components enabled the construction of high-order harmonic phasor thermographic vision (PTG-vision) without external illumination, matching the ground-truth RGB image.

In FIG. 4C, subpanels (i)-(j), the study verified the effectiveness of PTG by imaging a freshly picked flower with cold water droplets on its petal. Unlike the phantom hand, the plant specimen exhibited a broader temperature range and higher emissivity due to its water-rich composition, similar to that of biological tissues. In FIG. 4C, subpanels (k)-(n), the study conducted phasor transformation on the hyperspectral images and generated the 4^{th}-harmonic modulation and phase maps. As measured, sub-millimeter-wide filaments in the flower stamen could be resolved in the high-order harmonic modulation map, which was barely detectable from the petals in the 1^{st}-harmonic and conventional thermal images (see FIG. 4C, insets in subpanel (m)). In FIG. 4C, subpanel (o), the overlay of the modulation and phase maps provided a visualization of spatial transitions across different materials, with the phase showing a binary contrast due to its quasi-linear behavior. Furthermore, in FIG. 4C, subpanels (l)-(p), clustering the 4^{th}-harmonic phasors produced the material map, revealing subtle variations in the leaves and petals and the presence of water droplets due to moisture. In FIG. 4C, subpanel (q), with the spatial texture modulation and materials encoded into the phasor-enabled multiparametric thermal unmixing algorithm (see Table 1), the temperature details of the flower parts could be mapped. Water droplets, for example, appeared cooler than the petals (see FIG. 4C, subpanel (q)) due to evaporation, a thermal feature that was visually transparent and thus imperceptible in the RGB image (see FIG. 4C, subpanel (i)). Finally, the PTG-vision provided an enhanced, comprehensive display of the object's thermal features (see FIG. 4C, subpanel (r)).

Characterization of Texture Extraction. The study used a local standard deviation as a metric to quantify the performance of PTG-vision in texture extraction compared to conventional thermal imaging, specifically measuring texture density. Each pixel value in the texture density map was calculated as the standard deviation of the 3×3 neighborhood surrounding the corresponding pixel in the PTG-vision image. Texture density was also applied to the texture map from PTG-vision and to the non-linear regression-based thermal decomposition to quantify texture details, assess texture characteristics, and compare different texture extraction techniques. Texture density also provided a detailed and accurate representation of texture variations within the observed images.

Facial Infrared Thermography. Facial infrared thermography has been used in psychophysiology and medicine [37], [38] to facilitate noninvasive, precise assessment of physiological changes, vascular conditions, and potential early health issues by examining naturally exposed body parts without direct contact or external illumination [39]. However, the advancement of thermographic physiological characterization remained complicated by its sensitivity to ambient conditions, the ghosting effect from overlapping thermal emissions, and inadequate interpretation of facial heat signals.

In the study, the experimental system extended the current facial infrared thermal imaging by using hyperspectral thermal acquisition and phasor analysis. FIG. 4E shows hyperspectral thermal images of a human object generated by (i) the current facial infrared thermography system and (ii) the experimental system with phasor thermography (PTG).

In FIG. 4E, subpanel (a), a thermographic recording from the current facial infrared thermography system shows overlapping thermal radiation from all relevant targets and environmental scattering, with a constant emissivity across the scene, which did not reveal the precise temperature of the object of interest. In contrast, in FIG. 4E, subpanels (b)-(c), the experimental system provided the acquisition of hyperspectral images for high-order harmonic phasor analysis. As a result, in FIG. 4E, subpanels (d)-(f), the experimental system achieved accurate spatial texture modulation and material classification of major radiations, including various body parts and apparel, and environmental radiation. Specifically, in FIG. 4E, the high sensitivity and resolution of PTG in the experimental system facilitated distinguishing thermal variations, such as the facial skin (see subpanel (d)(i)), metal eyeglass rims and lenses (see subpanels (d)(iii) and (d)(iv)), subtypes of hair, including the thick, coarse terminal hair on the scalp and fine, short vellus hair on the eyebrow and nearing the scalp (see subpanels (d)(ii)-(d)(iv)), and the curtain behind the person (see subpanel (d)(iv)). The experimental system discerned noise components, including ambient radiation, the Narcissus effect of the detector, and reflections from the metal filter wheel (see FIG. 4E, subpanel (d)(v)). As a result, the enhanced modulation and material classification, while rejecting noise components, facilitated the determination of the temperature (see FIG. 4E, subpanel (g)), all made possible by the high-order harmonic thermal phasor analysis in the experimental system. In contrast to current first-order phasors, the PTG-vision derived from the high-order harmonic phasor analysis displayed improved clarity and resolution in visualizing thermal fingerprints in materials, texture modulation, and temperature, thereby strengthening quantification of the passive facial anatomy and composites (see FIG. 4E, subpanels (h)-(i)). PTG-vision exhibited two-fold improvement in the maximum texture density compared to the state-of-the-art thermal image, resulting in enhanced facial recognition (see FIG. 4E, subpanels (j) and (k)).

Thermographic Detection of Human Vital Signs. Thermal signal detection provided noninvasive and contact-free monitoring and spatial visualization of a diverse array of physiological parameters with accuracy and convenience [12], [13]. For broader applicability, the thermal signal detection system in clinical and non-clinical settings required enhanced resolution, sensitivity, and robustness to distinguish among various physiological and non-physiological heat sources and to mitigate ambient interference with the thermal signals.

The study demonstrated the experimental system's ability to advance thermal imaging and analysis of human vital signs. The experimental system facilitated synchronized hyperspectral acquisition and the detailed extraction of vital signs such as respiration and pulse rates. FIG. 4F shows the thermographic detection of human vital signs using the experimental system.

In FIG. 4F, subpanel (a), the high sensitivity and multiparametricity of the experimental system differentiated facial texture and materials, facilitating accurate detection of subtle, pulse-induced facial variations. For instance, in FIG. 4F, subpanel (b), healthy adults were recorded at 5 frames/second, and the corresponding pulse rates of 60-80 beats per minute (bpm) were identified from the frequency analysis of the temporal signal at each pixel in the vessel-rich forehead area. In FIG. 4F, subpanel (c), the experimental system also facilitated the identification and visualization of indirect, obscured facial signals, including the determination of time-lapse temperature and texture changes in a face-covering mask, both associated with respiratory cycles. Specifically, in FIG. 4F, subpanel (c)(iii), the experimental system obtained temperature measurements by suppressing intermittent deviations caused by filter changes. Also, in FIG. 4F, subpanel (c)(ii), the PTG-derived temperature map, due to the slow thermal dissipation on the mask, exhibited values more consistent with the actual body temperature than the state-of-the-art thermal measurements. In FIG. 4F, subpanel (c)(iii), high-order harmonic phasor analysis augmented the texture variations of the mask over the exhaling and inhaling respiratory cycles, detecting respiration rates of 10-20 breaths per minute through the frequency analysis of the texture modulation near the nasal area. Similarly, the experimental system could differentiate vital signs in scenes with multiple human subjects, in which sensitive PTG-vision revealed facial temperature gradients attributable to mutual radiation interactions between individuals.

In FIG. 4F, subpanel (d), the study monitored the facial thermal features in a human subject over an exercise period. In FIG. 4F, subpanel (e), the PTG images of the naso-oral region revealed a nearly 0.8° C. increase in facial temperature after the exercise. In FIG. 4F, subpanels (f)-(g), the spatial variations around the eyes due to sweat were resolved using PTG in the experimental system, which were otherwise undetectable in state-of-the-art thermal images with constant emissivity. In FIG. 4F, subpanel (h), high-order harmonic modulation maps near the nasal area facilitated the capture of changes resulting from respiration cycles over the exercise period. In FIG. 4F, subpanel (i), the corresponding pixel-wise frequency analysis of the texture-modulation sequences documented the gradual recovery of respiratory rates back to the resting state over 10 minutes following exercise.

In addition to extracting facial features, the experimental system detected vital signals of other body parts of interest, such as the hand and neck regions. In FIG. 4F, the high-order harmonic analysis based on the wrist yielded a clear thermographic vision of the vascular patterns underneath the skin (see subpanels (j)-(m)) and, thus, a consistent measurement of the pulse rate of 70-80 bpm (see subpanel (n)). The study also imaged the dorsal side of the hand using the experimental system and distinguished the subcutaneous veins from the surrounding skin tissues. Due to higher water and hemoglobin concentrations, the blood exhibited distinct absorptance relative to skin tissue, particularly in the visible and near-infrared spectra [40], [41]. Diffuse optics has been used to measure tissue hemodynamics, but it has remained insufficient for displaying thermal features [42]. In FIG. 4F, subpanels (o)-(q), the study achieved visualization of this photothermal process with thermographic clarity and sensitivity, using the experimental system. Specifically, in FIG. 4F, subpanel (r), the hemodynamics of the blood vessels were documented in their high-resolution sub-millimeter anatomy and in the vascular temperature, which increased by nearly 0.6° C. upon near-infrared illumination (e.g., 850 nm) and subsequent thermal dissipation. This PTG-enhanced approach (using the experimental system) to display thermographic vascular features provided a pathway toward a comprehensive understanding of subcutaneous vascular anatomy and hemodynamics.

### DISCUSSION

Accurate, non-invasive monitoring of vital signs, such as heart rate, respiratory rate, and body temperature, which reflect fundamental human physiological conditions, is paramount in clinical, healthcare, and self-wellness settings [1-3]. Current methods for measuring vital signs involve contact-based devices, such as electrocardiograms and pulse oximeters for heart rate, capnography or respiratory inductance plethysmography for respiratory rate, and thermometers for body temperature. The current methods, while effective, can require direct contact or cannot provide continuous and comprehensive monitoring. The recent development of wearable health-monitoring devices, such as smart watches, fitness bands, and adhesive patches, can facilitate continuous ambulatory monitoring of vital signs [4-7]. However, most current wearable health-monitoring devices require direct physical contact, and their adaptability may be limited for users with skin irritations, wounds, or insufficient skin area.

Radar-based sensors provide an alternative to contact-based systems for the remote and continuous monitoring of physiological parameters [8], [9]. The radar-based sensors can penetrate clothing and other obstacles, providing accurate and secure measurements without requiring direct contact or line of sight. Nonetheless, challenges such as limited spatial information, hardware and signal-processing complexity, and potential calibration and interference issues can limit their widespread use. In contrast, camera-based methods provide advantages for non-contact vital-sign monitoring [10], [11]. They enable continuous tracking of physiological parameters by capturing visual data from specific body regions, providing a comfortable, unobtrusive experience for patients. Unlike radar systems, cameras provide additional spatial context and visual details for specific regions of interest, enabling a versatile array of physiological measurements [11], [12]. The camera technology facilitates the processing of irrelevant body movements while extracting functional data, making it suitable for unsupervised monitoring scenarios. Furthermore, camera-based systems depend less on complex hardware and signal processing, facilitating integration into healthcare environments [13].

Thermography, a specialized camera-based method, captures passive infrared thermal radiation independent of ambient light conditions. This method has found utility across diverse applications [14-21], such as navigation, sensing, thermodynamics, and materials science. Notably, thermal imaging has advanced the medical and health domains [22], [23], facilitating tasks such as exploring human physiology, disease detection, vascular disorder assessment, inflammation monitoring, and early-stage cancer screening. Despite advancements, current systems still encounter limitations, primarily due to spectral ambiguity in thermography [24], [25]. Unlike quasi-passive systems (e.g., visible optical imaging), thermal radiation from target objects and environmental scattering exhibit broad, overlapping emission spectra, leading to the ghosting effect, in which texture details are immersed and thus imperceptible in strong direct emission [24]. The lack of spectral resolution complicates the interpretation of heat signals, which cannot be resolved using standard optical filtering settings. The limitations pose challenges for functional monitoring, where it is essential to differentiate subtle physiological changes, given the thermal similarities among sources such as body parts, apparel, and the surrounding environment. Phasor analysis provides a rapid and accurate approach to analyzing hyperspectral imaging and fluorescence-lifetime imaging microscopy (FLIM) data, yielding a reproducible and robust method for spectral unmixing and signal analysis in the visible spectrum [26-29]. Phasor analysis has been implemented for cell and tissue segmentation in hyperspectral microscopic and spectroscopic imaging [27], [30-32]. Building on its efficacy across various domains and high computational efficiency [26], [29], phasor analysis can be applied to hyperspectral thermal imaging in the long-wave infrared (LWIR) spectrum for the first time to enhance thermal imaging quality, enable accurate material segmentation, and capture subtle physiological variations.

The exemplary phasor thermography (PTG) system is a hyperspectral, high-resolution, and multiparametric thermographic imaging and vision system. The exemplary system uses hyperspectral radiation modeling and thermal phasor analysis to depict key thermal fingerprints. Specifically, the exemplary system uses full-harmonics phasor energy and high-order thermal phasor perception, leading to enhanced texture extraction and material classification. This advancement facilitates precise unmixing and high-resolution estimation of essential physical attributes in a thermal scene (e.g., temperature, emissivity, texture modulation), thereby mitigating inadequate temperature identification when decomposition is performed from the total thermal radiation. Furthermore, the exemplary system provides computational efficiency through system-aware deterministic modeling, demonstrates robustness to complex and non-uniform environmental radiation sources, and is compatible with all major infrared thermography platforms. In the study, the exemplary system was validated using various phantoms and living subjects at room temperature. The results show the exemplary system's passive and reliable detection of human vital signs, including temperature, respiration rate, and heart rate, across various body regions. The exemplary system can advance medical thermography and strengthen the applicability of infrared imaging across diverse fields.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special-purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.

### REFERENCE LIST #1

[1] Considine, J. et al. Importance of specific vital signs in nurses' recognition and response to deteriorating patients: A scoping review. J Clin Nurs 33, 2544-2561 (2024). https://doi.org/10.1111/jocn.17099
[2] Sullivan, B. A. & Fairchild, K. D. Vital signs as physiomarkers of neonatal sepsis. Pediatric research 91, 273-282 (2022).
[3] Manta, C., Jain, S. S., Coravos, A., Mendelsohn, D. & Izmailova, E. S. An Evaluation of Biometric Monitoring Technologies for Vital Signs in the Era of COVID-19. Clin Transl Sci 13, 1034-1044 (2020). https://doi.org/10.1111/cts.12874
[4] Zhao, C., Park, J., Root, S. E. & Bao, Z. Skin-inspired soft bioelectronic materials, devices and systems. Nature Reviews Bioengineering (2024). https://doi.org/10.1038/s44222-024-00194-1
[5] Walter, J. R., Xu, S. & Rogers, J. A. From lab to life: how wearable devices can improve health equity. Nat Commun 15, 123 (2024). https://doi.org/10.1038/s41467-023-44634-9
[6] Lu, L. et al. Wearable Health Devices in Health Care: Narrative Systematic Review. JMIR Mhealth Uhealth 8, e18907 (2020). https://doi.org/10.2196/18907
[7] Varnava, C. Vital signs monitoring goes into the cloud. Nature Electronics 2, 432-432 (2019). https://doi.org/10.1038/s41928-019-0324-0
[8] Mercuri, M. et al. Vital-sign monitoring and spatial tracking of multiple people using a contactless radar-based sensor. Nature Electronics 2, 252-262 (2019). https://doi.org/10.1038/s41928-019-0258-6
[9] Zhang, Z., Liu, Y., Stephens, T. & Eggleton, B. J. Photonic radar for contactless vital sign detection. Nature Photonics 17, 791-797 (2023). https://doi.org/10.1038/s41566-023-01245-6
[10] Huang, B. et al. Challenges and prospects of visual contactless physiological monitoring in clinical study. NPJ Digit Med 6, 231 (2023). https://doi.org/10.1038/s41746-023-00973-x
[11] McDuff, D. Camera measurement of physiological vital signs. ACM Computing Surveys 55, 1-40 (2023).
[12] Tarmizi, S. S. A., Suriani, N. S. & Rashid, F. A. N. A Review of Facial Thermography Assessment for Vital Signs Estimation. IEEE Access 10, 115583-115602 (2022). https://doi.org/10.1109/access.2022.3217904
[13] Selvaraju, V. et al. Continuous Monitoring of Vital Signs Using Cameras: A Systematic Review. Sensors (Basel) 22 (2022). https://doi.org/10.3390/s22114097
[14] Bao, F. et al. Heat-assisted detection and ranging. Nature 619, 743-748 (2023). https://doi.org/10.1038/s41586-023-06174-6
[15] Corbett, D. C. et al. Thermofluidic heat exchangers for actuation of transcription in artificial tissues. Sci Adv 6 (2020). https://doi.org/10.1126/sciadv.abb9062
[16] Wang, Y., Jin, D., Chen, J. & Bai, X. Revelation of hidden 2D atmospheric turbulence strength fields from turbulence effects in infrared imaging. Nat Comput Sci 3, 687-699 (2023). https://doi.org/10.1038/s43588-023-00498-z
[17] Daimon, S., Iguchi, R., Hioki, T., Saitoh, E. & Uchida, K. I. Thermal imaging of spin Peltier effect. Nat Commun 7, 13754 (2016). https://doi.org/10.1038/ncommsl3754
[18] Agrenius, T., Gonzalez-Ballestero, C., Maurer, P. & Romero-Isart, O. Interaction between an Optically Levitated Nanoparticle and Its Thermal Image: Internal Thermometry via Displacement Sensing. Phys Rev Lett 130, 093601 (2023). https://doi.org/10.1103/PhysRevLett.130.093601
[19] Ziabari, A. et al. Full-field thermal imaging of quasiballistic crosstalk reduction in nanoscale devices. Nat Commun 9, 255 (2018). https://doi.org/10.1038/s41467-017-02652-4
[20] Halbertal, D. et al. Nanoscale thermal imaging of dissipation in quantum systems. Nature 539, 407-410 (2016). https://doi.org/10.1038/nature19843
[21] Tang, K. et al. Millikelvin-resolved ambient thermography. Sci Adv 6 (2020). https://doi.org/10.1126/sciadv.abd8688
[22] Zivcak J.; Madarasz, L. H., R.; Rudas, I. J. Methodology, Models, and Algorithms in Thermographic Diagnostics. Vol. 5 195-196 (Springer, Berlin, Heidelberg, 2013).
[23] Lahiri, B. B., Bagavathiappan, S., Jayakumar, T. & Philip, J. Medical applications of infrared thermography: A review. Infrared Phys Technol 55, 221-235 (2012). https://doi.org/10.1016/j.infrared.2012.03.007
[24] Bao, F. et al. Why thermal images are blurry. Opt Express 32, 3852-3865 (2024). https://doi.org/10.1364/OE.506634
[25] Gurton, K. P., Yuffa, A. J. & Videen, G. W. Enhanced facial recognition for thermal imagery using polarimetric imaging. Opt Lett 39, 3857-3859 (2014). https://doi.org/10.1364/OL.39.003857
[26] Malacrida, L. Phasor plots and the future of spectral and lifetime imaging. Nat Methods 20, 965-967 (2023). https://doi.org/10.1038/s41592-023-01906-y
[27] Cutrale, F. et al. Hyperspectral phasor analysis enables multiplexed 5D in vivo imaging. Nat Methods 14, 149-152 (2017). https://doi.org/10.1038/nmeth.4134
[28] Malacrida, L., Ranjit, S., Jameson, D. M. & Gratton, E. The Phasor Plot: A Universal Circle to Advance Fluorescence Lifetime Analysis and Interpretation. Annu Rev Biophys 50, 575-593 (2021). https://doi.org/10.1146/annurev-biophys-062920-063631
[29] Farzad Feridouni, A. N. B., and Hans C. Gerritsen. Spectral phasor analysis allows rapid and reliable unmixing of fluorescence microscopy spectral images. Opt Express 20, 12729-12741 (2012).
[30] Fu, D. & Xie, X. S. Reliable cell segmentation based on spectral phasor analysis of hyperspectral stimulated Raman scattering imaging data. Anal Chem 86, 4115-411 (2014). https://doi.org/10.1021/ac500014b
[31] Yao, Z. et al. Multiplexed bioluminescence microscopy via phasor analysis. Nat Methods 19, 893-898 (2022). https://doi.org/10.1038/s41592-022-01529-9
[32] Mukherjee, S. S. & Bhargava, R. Phasor Representation Approach for Rapid Exploratory Analysis of Large Infrared Spectroscopic Imaging Data Sets. Anal Chem 95, 11365-11374 (2023). https://doi.org/10.1021/acs.analchem.3c01539
[33] Hassanzadeh, M. & Shahrrava, B. Linear Version of Parseval's Theorem. IEEE Access 10, 27230-27241 (2022). https://doi.org/10.1109/access.2022.3157736
[34] Callen, H. B. Thermodynamics and an Introduction to Thermostatistics. (John wiley & sons, 1991).
[35] Kodinariya, T. M. & Makwana, P. R. Review on determining number of Cluster in K Means Clustering. International Journal of Advance Research in Computer Science and Management Studies. (2013).
[36] Sinaga, K. P. & Yang, M.-S. Unsupervised K-Means Clustering Algorithm. IEEE Access 8, 80716-80727 (2020). https://doi.org/10.1109/access.2020.2988796
[37] Cardone, D., Cerritelli, F., Chiacchiaretta, P., Perpetuini, D. & Merla, A. Facial functional networks during resting state revealed by thermal infrared imaging. Phys Eng Sci Med 46, 1573-1588 (2023). https://doi.org/10.1007/s13246-023-01321-9
[38] Perpetuini, D., Cardone, D., Bucco, R., Zito, M. & Merla, A. Assessment of the Autonomic Response in Alzheimer's Patients During the Execution of Memory Tasks: A Functional Thermal Imaging Study. Curr Alzheimer Res 15, 951-958 (2018). https://doi.org/10.2174/1871529X18666180503125428
[39] Fernández-Cuevas, I. et al. Classification of factors influencing the use of infrared thermography in humans: A review. Infrared Physics & Technology 71, 28-55 (2015). https://doi.org/10.1016/j.infrared.2015.02.007
[40] Abd Rahman, A. B., Juhim, F., Chee, F. P., Bade, A. & Kadir, F. Near Infrared Illumination Optimization for Vein Detection: Hardware and Software Approaches. Applied Sciences 12 (2022). https://doi.org/10.3390/app122111173
[41] Yaprak, E. & Kayaalti-Yuksek, S. Preliminary evaluation of near-infrared vein visualization technology in the screening of palatal blood vessels. Med Oral Patol Oral Cir Bucal 23, e98-e104 (2018). https://doi.org/10.4317/medoral.21996
[42] Durduran, T., Choe, R., Baker, W. B. & Yodh, A. G. Diffuse Optics for Tissue Monitoring and Tomography. Rep Prog Phys 73 (2010). https://doi.org/10.1088/0034-4885/73/7/076701
[43] Xu, Y., Lu, L., Saragadam, V. & Kelly, K. F. A compressive hyperspectral video imaging system using a single-pixel detector. Nat Commun 15, 1456 (2024). https://doi.org/10.1038/s41467-024-45856-1
[44] He, X. et al. A microsized optical spectrometer based on an organic photodetector with an electrically tunable spectral response. Nature Electronics (2024). https://doi.org/10.1038/s41928-024-01199-9
[45] Shin, U., Park, J. & Kweon, I. S. in Proceedings of the IEEE/CVF Conference on Computer Vision and Pattern Recognition 1043-1053 (2023).
[46] Rivadeneira, R. E., Sappa, A. D. & Vintimilla, B. X. in VISIGRAPP (4: VISAPP) 111-119 (2020).
[47] Fang, J. et al. Wide-field mid-infrared hyperspectral imaging beyond video rate. Nat Commun 15, 1811 (2024). https://doi.org/10.1038/s41467-024-46274-z
[48] Zhao, Y. et al. High-speed scanless entire bandwidth mid-infrared chemical imaging. Nat Commun 14, 3929 (2023). https://doi.org/10.1038/s41467-023-39628-6
[49] Huang, L. et al. Broadband thermal imaging using meta-optics. Nat Commun 15, 1662 (2024). https://doi.org/10.1038/s41467-024-45904-w
[50] Fan, S. & Li, W. Photonics and thermodynamics concepts in radiative cooling. Nature Photonics 16, 182-190 (2022). https://doi.org/10.1038/s41566-021-00921-9
[51] Osborn, L. E. et al. Evoking natural thermal perceptions using a thin-film thermoelectric device with high cooling power density and speed. Nat Biomed Eng (2023). https://doi.org/10.1038/s41551-023-01070-w
[52] Reader, J. T. et al. Waterproof, electronics-enabled, epidermal microfluidic devices for sweat collection, biomaker analysis, and thermography in aquatic settings. Sci. Adv. 5, u6256 (2019).
[53] Lin, M. et al. Improving model fairness in image-based computer-aided diagnosis. Nat Commun 14, 6261 (2023). https://doi.org/10.1038/s41467-023-41974-4
[54] B., A. Complex numbers and phasors. In Foundations of Electromagnetic Compatibility: With Practical Applications, 109-140. (2017).
[55] De Oliveira H M, N. F. About the phasor pathways in analogical amplitude modulations. Int J Res Eng Sci 2, 11-18 (2014).
[56] Hedde, P. N., Cinco, R., Malacrida, L., Kamaid, A. & Gratton, E. Phasor-based hyperspectral snapshot microscopy allows fast imaging of live, three-dimensional tissues for biomedical applications. Commun Biol 4, 721 (2021). https://doi.org/10.1038/s42003-021-02266-z
[57] Digman, M. A., Caiolfa, V. R., Zamai, M. & Gratton, E. The phasor approach to fluorescence lifetime imaging analysis. Biophys J 94, L14-16 (2008). https://doi.org/10.1529/biophysj.107.120154
[58] Ranjit, S., Malacrida, L., Jameson, D. M. & Gratton, E. Fit-free analysis of fluorescence lifetime imaging data using the phasor approach. Nat Protoc 13, 1979-2004 (2018). https://doi.org/10.1038/s41596-018-0026-5
[59] Spencer, R. D. & Weber, G. Measurements of Subnanosecond Fluorescence Lifetimes with a Cross-Correlation Phase Fluorometer*. Annals of the New York Academy of Sciences 158, 361-376 (2007). https://doi.org/10.1111/j.1749-6632.1969.tb56231.x
[60] Schuty, B. et al. Quantitative melanoma diagnosis using spectral phasor analysis of hyperspectral imaging from label-free slices. Front Oncol 13, 1296826 (2023). https://doi.org/10.3389/fonc.2023.1296826
[61] Graciani, G. & Amblard, F. Super-resolution provided by the arbitrarily strong superlinearity of the blackbody radiation. Nat Commun 10, 5761 (2019). https://doi.org/10.1038/s41467-019-13780-4
[62] Yu, Z. et al. Thermal facial image analyses reveal quantitative hallmarks of aging and metabolic diseases. Cell Metab 36, 1482-1493 e1487 (2024). https://doi.org/10.1016/j.cmet.2024.05.012
[63] Han, D., Shu, J. Phasor Thermography. Zenodo. (2025) DOI: 10.5281/zenodo.14851702.

### REFERENCE LIST #2

[1′] Charlton, M. et al. The effect of constitutive pigmentation on the measured emissivity of human skin. PLoS One 15, e0241843 (2020). https://doi.org/10.1371/journal.pone.0241843
[2′] Zhang, H., Hu, T. L. & Zhang, J. C. Surface emissivity of fabric in the 8-14 m waveband. Journal of the Textile Institute 100, 90-94 (2009). https://doi.org/10.1080/00405000701692486
[3′] Zivcak J.; Madarasz, L. H., R.; Rudas, I. J. Methodology, Models, and Algorithms in Thermographic Diagnostics. Vol. 5 195-196 (Springer, Berlin, Heidelberg, 2013).
[4′] Goddijn-Murphy, L. & Williamson, B. On Thermal Infrared Remote Sensing of Plastic Pollution in Natural Waters. Remote Sensing 11 (2019). https://doi.org/10.3390/rs11182159
[5′] Kodinariya, T. M. & Makwana, P. R. Review on determining number of Cluster in K-Means Clustering. International Journal of Advance Research in Computer Science and Management Studies. (2013).
[6′] Sinaga, K. P. & Yang, M.-S. Unsupervised K-Means Clustering Algorithm. IEEE Access 8, 80716-80727 (2020). https://doi.org/10.1109/access.2020.2988796
[7′] Bao, F. et al. Why thermal images are blurry. Opt Express 32, 3852-3865 (2024). https://doi.org/10.1364/OE.506634
[8′] Bao, F. et al. Heat-assisted detection and ranging. Nature 619, 743-748 (2023). https://doi.org/10.1038/s41586-023-06174-6
[9′] Dang, K. & Sharma, S. 629-633 (2017).
[10′] Jadhav, A. L., S.; Matey, S.; Madamwar, T.; Jakhete, S.; & Survey on face detection algorithms. International Journal of Innovative Science and Research Technology 6, 291-297 (2021).
[11′] Osborn, L. E. et al. Evoking natural thermal perceptions using a thin-film thermoelectric device with high cooling power density and speed. Nat Biomed Eng (2023). https://doi.org/10.1038/s41551-023-01070-w
[12′] Varnava, C. Vital signs monitoring goes into the cloud. Nature Electronics 2, 432-432 (2019). https://doi.org/10.1038/s41928-019-0324-0
[13′] Franklin, D. et al. Synchronized wearables for the detection of haemodynamic states via electrocardiography and multispectral photoplethysmography. Nat Biomed Eng 7, 1229-1241 (2023). https://doi.org/10.1038/s41551-023-01098-y
[14′] Mercuri, M. et al. Vital-sign monitoring and spatial tracking of multiple people using a contactless radar-based sensor. Nature Electronics 2, 252-262 (2019). https://doi.org/10.1038/s41928-019-0258-6
[15′] Zhang, Z., Liu, Y., Stephens, T. & Eggleton, B. J. Photonic radar for contactless vital sign detection. Nature Photonics 17, 791-797 (2023). https://doi.org/10.1038/s41566-023-01245-6.

What is claimed:

1. A thermographic imaging and vision system comprising:
at least one two-dimensional (2D) sensor configured to capture one or more thermal radiance images having pixels;
at least one filter operatively coupled to the at least one sensor to facilitate capture of one or more thermal radiance images of a person, wherein the at least one filter is configured to filter the captured one or more thermal radiance images at one or more predefined frequency bands to provide hyperspectral information across an electromagnetic spectrum for each pixel in the captured one or more thermal radiance images; and
a controller operatively coupled to the at least one sensor, the controller comprising:
a processor; and
a memory having instructions stored thereon, wherein execution of the instructions causes the processor to:
receive, via the at least one sensor, the filtered one or more thermal radiance images;
generate, via a thermal phasor transformation operation, one or more phasor data at one or more harmonics using the filtered one or more thermal radiance images, wherein each phasor data represents characteristics of thermal radiance at the one or more predefined frequency bands;
generate, via a phasor modulation operation, a texture modulation map within a phasor data of the one or more phasor data at a pre-defined high-order harmonic, wherein the generated texture modulation map includes texture values represented by the phasor data;
generate, via a trained AI model or cluster algorithm, a material segmentation map by partitioning phasors within the generated one or more phasor data into one or more clusters, wherein the material segmentation map includes emissivity values of materials represented by the phasors;
generate, via the trained AI model or a thermal decomposition algorithm, a temperature map having a plurality of temperature values, wherein each temperature value is computed using (i) the emissivity values from the generated material segmentation map and (ii) the texture values from the generated texture modulation map;
generate a phasor thermographic image by combining at least two of the generated material segmentation maps, the generated temperature map, and the generated texture modulation map; and
output the generated phasor thermographic image, wherein the output is subsequently employed for health monitoring or medical diagnoses.

2. The system of claim 1, wherein the generation of the texture modulation map is based on phasor modulation within the phasor data at a 4^{th} harmonic.

3. The system of claim 1, wherein the partitioning of the phasors within the generated one or more phasor data into the one or more clusters includes:
selecting one or more phasors as one or more cluster centers;
partitioning phasors located within a predefined distance from the one or more cluster centers into one or more clusters; and
assigning a value to each of the one or more clusters, wherein each cluster forms a segment of the material segmentation map.

4. The system of claim 1, wherein the instructions to generate the temperature map includes:
instructions to determine, via an material-emissivity library, an emissivity value (e) for a given pixel in the one or more thermal radiance images, wherein the given pixel corresponds to a segmented material in the generated material segmentation map;
instructions to determine a lighting factor value for the given pixel in the one or more thermal radiance images, wherein the lighting factor for the given pixel corresponds to a segmented texture modulation in the generated texture modulation map; and
instructions to determine a temperature value for the given pixel in the one or more thermal radiance images using the determined emissivity value and the determined lighting factor for the given pixel, wherein a plurality of determined temperature values for a plurality of pixels in the one or more thermal radiance images form the generated temperature map.

5. The system of claim 1, wherein at least one sensor further includes a metasurface.

6. The system of claim 1, wherein the at least one sensor is selected from the group consisting of a red-green-blue camera and a forward-looking infrared camera.

7. The system of claim 1, wherein the trained AI model is a neural network model.

8. The system of claim 1, wherein the trained AI model was trained using the generated phasor thermographic image.

9. The system of claim 1, wherein the execution of the instructions further causes the processor to:
receive a first thermal radiance image in the one or more thermal radiance images as a fixed reference; and
configure other thermal radiance images to be aligned with the received first thermal radiance image.

10. The system of claim 1, wherein the one or more predefined frequency bands include long-wave infrared bands.

11. The system of claim 1, wherein the controller is located in part in a cloud infrastructure comprising a network interface configured to communicatively operate with the at least one sensor through a network, wherein generation of the phasor thermographic image is performed at the cloud infrastructure.

12. The system of claim 1, wherein the controller is located in part in a mobile device comprising a network interface configured to communicatively operate with the at least one sensor through a network, wherein generation of the phasor thermographic image is performed at the mobile device.

13. The system of claim 1, wherein the at least one filter includes (i) a first filter that is coupled to a first sensor and (ii) a second filter that is coupled to a second sensor, wherein outputs of the first sensor and the second sensor collectively provide hyperspectral information across the electromagnetic spectrum for the each pixel in the captured one or more thermal radiance images.

14. The system of claim 1, wherein the at least one filter includes a first filter and a second filter, each movable via an actuator to be disposed before the at least one filter, wherein acquisition of outputs of the at least one filter (i) at the first filter at a first time instance and (ii) at the second filter at a second time instance collectively provide hyperspectral information across the electromagnetic spectrum for the each pixel in the captured one or more thermal radiance images.

15. A method comprising:
receiving, via at least one two-dimensional (2D) sensor coupled to at least one filter or metasurface, filtered one or more thermal radiance images of a person, wherein the at least one filter or metasurface is configured to filter one or more thermal radiance images captured by the at least one sensor at one or more predefined frequency bands to provide hyperspectral information across an electromagnetic spectrum for each pixel in the captured one or more thermal radiance images;
generating, via a thermal phasor transformation operation, one or more phasor data at one or more harmonics using the filtered one or more thermal radiance images, wherein each phasor data represents characteristics of thermal radiance at the one or more predefined frequency bands;
generating, via a phasor modulation operation, a texture modulation map within a phasor data of the one or more phasor data at a pre-defined high-order harmonic, wherein the generated texture modulation map includes texture values represented by the phasor data;
generating, via a trained AI model or cluster algorithm, a material segmentation map by partitioning phasors within the generated one or more phasor data into one or more clusters, wherein the material segmentation map includes emissivity values of materials represented by the phasors;
generating, via the trained AI model or a thermal decomposition algorithm, a temperature map having a plurality of temperature values, wherein each temperature value is computed using (i) the emissivity values from the generated material segmentation map and (ii) the texture values from the generated texture modulation map;
generating a phasor thermographic image by combining at least two of the generated material segmentation map, the generated temperature map, and the generated texture modulation map; and
outputting the generated phasor thermographic image, wherein the output is subsequently employed for health monitoring or medical diagnoses.

16. The method of claim 15, wherein the partitioning of the phasors within the generated one or more phasor data into the one or more clusters includes:
selecting one or more phasors as one or more cluster centers;
partitioning phasors located within a predefined distance from the one or more cluster centers into one or more clusters; and
assigning a value to each of the one or more clusters, wherein each cluster forms a segment of the material segmentation map.

17. The method of claim 15, wherein generating the temperature map includes:
determining, via a material-emissivity library, an emissivity value (e) for a given pixel in the one or more thermal radiance images, wherein the given pixel corresponds to a segmented material in the generated material segmentation map;
determining a lighting factor value for the given pixel in the one or more thermal radiance images, wherein the lighting factor for the given pixel corresponds to a segmented texture modulation in the generated texture modulation map; and
determining a temperature value for the given pixel in the one or more thermal radiance images using the determined emissivity value and the determined lighting factor for the given pixel, wherein a plurality of determined temperature values for a plurality of pixels in the one or more thermal radiance images form the generated temperature map.

18. The method of claim 15, wherein the generation of the texture modulation map is based on phasor modulation within the phasor data at a 4^{th} harmonic.

19. The method of claim 15, wherein the filtered one or more thermal radiance images are acquired via a single sensor that operates with a plurality of filters that are configured to move during the acquisition.

20. The method of claim 15, wherein the filtered one or more thermal radiance images are acquired via multiple sensors that each operate with a filter.

21. A non-transitory computer-readable medium having instructions stored thereon, wherein execution of the instructions by a processor causes the processor to:
receive, via at least one sensor, filtered one or more thermal radiance images;
generate, via a thermal phasor transformation operation, one or more phasor data at one or more harmonics using the filtered one or more thermal radiance images, wherein each phasor data represents characteristics of thermal radiance at one or more predefined frequency bands;
generate, via a phasor modulation operation, a texture modulation map within a phasor data of the one or more phasor data at a pre-defined high-order harmonic, wherein the generated texture modulation map includes texture values represented by the phasor data;
generate, via a trained AI model or cluster algorithm, a material segmentation map by partitioning phasors within the generated one or more phasor data into one or more clusters, wherein the material segmentation map includes emissivity values of materials represented by the phasors;
generate, via the trained AI model or a thermal decomposition algorithm, a temperature map having a plurality of temperature values, wherein each temperature value is computed using (i) the emissivity values from the generated material segmentation map and (ii) the texture values from the generated texture modulation map;
generate a phasor thermographic image by combining at least two of the generated material segmentation map, the generated temperature map, and the generated texture modulation map; and
output the generated phasor thermographic image, wherein the output is subsequently employed for health monitoring or medical diagnoses.
